(19) United States
(12) Patent Application Publication
(10) Pub. No.: US 2025/0096997 A1
(43) Pub. Date: Mar. 20, 2025

(54) PARAMETER SETS FOR USER EQUIPMENT COMMUNICATION MODES

(71) Applicant: QUALCOMM Incorporated, San Diego, CA (US)

(72) Inventors: Qian ZHANG, Basking Ridge, NJ (US); Yan ZHOU, San Diego, CA (US); Tao LUO, San Diego, CA (US)

(21) Appl. No.: 18/471,082

(22) Filed: Sep. 20, 2023

(51) Int. Cl. H04L 5/14; H04W 88/06

(52) U.S. Cl. CPC H04L 5/14; H04W 88/06

(57) ABSTRACT

Various aspects of the present disclosure generally relate to wireless communication. In some aspects, a user equipment (UE) may transmit, to a network node, capability information associated with two or more communication modes of a plurality of communication modes, the two or more communication modes comprising at least one full duplex (FD) mode. The UE may receive, from the network node, configuration information associated with the two or more communication modes, the configuration information indicating at least two sets of parameter values, wherein each set of parameter values is associated with a respective communication mode of the two or more communication modes. The UE may communicate with the network node based at least in part on the at least two sets of parameter values. Numerous other aspects are described.

### FIELD OF THE DISCLOSURE

Aspects of the present disclosure generally relate to wireless communication and to techniques and apparatuses for parameter sets for user equipment communication modes.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a user equipment (UE). The apparatus may include one or more memories and one or more processors coupled to the one or more memories. The one or more processors may be configured to transmit, to a network node, capability information associated with two or more communication modes of a plurality of communication modes, the two or more communication modes comprising at least one full duplex (FD) mode. The one or more processors may be configured to receive, from the network node, configuration information associated with the two or more communication modes, the configuration information indicating at least two sets of parameter values, wherein each set of parameter values is associated with a respective communication mode of the two or more communication modes. The one or more processors may be configured to communicate with the network node based at least in part on the at least two sets of parameter values.

Some aspects described herein relate to an apparatus for wireless communication at a network node. The apparatus may include one or more memories and one or more processors coupled to the one or more memories. The one or more processors may be configured to receive, from a UE, capability information associated with two or more communication modes of a plurality of communication modes, the two or more communication modes comprising at least one FD mode. The one or more processors may be configured to transmit, to the UE, configuration information associated with the two or more communication modes, the configuration information indicating at least two sets of parameter values, wherein each set of parameter values is associated with a respective communication mode of the two or more communication modes. The one or more processors may be configured to communicate with the UE based at least in part on the at least two sets of parameter values.

Some aspects described herein relate to an apparatus for wireless communication at a UE. The apparatus may include one or more memories and one or more processors coupled to the one or more memories. The one or more processors may be configured to receive, from a network node, configuration information associated with two or more communication modes, of a plurality of communication modes, the two or more communication modes comprising at least one FD mode. The one or more processors may be configured to communicate with the network node, in association with a first communication mode of the two or more communication modes. The one or more processors may be configured to communicate, associated with a mode transition condition, with the network node in association with a second communication mode of the two or more communication modes, wherein the mode transition condition is associated with a maximum number of transition points during a specified time period.

Some aspects described herein relate to an apparatus for wireless communication at a network node. The apparatus may include one or more memories and one or more processors coupled to the one or more memories. The one or more processors may be configured to transmit, to a UE, configuration information associated with two or more communication modes, of a plurality of communication modes, the two or more communication modes comprising at least one FD mode. The one or more processors may be configured to communicate with the UE in association with a first communication mode of the two or more communication modes. The one or more processors may be configured to communicate, associated with a mode transition condition, with the UE in association with a second communication mode of the two or more communication modes, wherein the mode transition condition is associated with a maximum number of transition points during a specified time period.

Some aspects described herein relate to a method of wireless communication performed by an apparatus at a UE. The method may include transmitting, by the UE and to a network node, capability information associated with two or more communication modes of a plurality of communication modes, the two or more communication modes comprising at least one FD mode. The method may include receiving, by the UE and from the network node, configuration information associated with the two or more communication modes, the configuration information indicating at least two sets of parameter values, wherein each set of parameter values is associated with a respective communication mode of the two or more communication modes. The method may include communicating, by the UE, with the network node based at least in part on the at least two sets of parameter values.

Some aspects described herein relate to a method of wireless communication performed by an apparatus at a network node. The method may include receiving, by the network node and from a UE, capability information associated with two or more communication modes of a plurality of communication modes, the two or more communication modes comprising at least one FD mode. The method may include transmitting, by the network node and to the UE, configuration information associated with the two or more communication modes, the configuration information indicating at least two sets of parameter values, wherein each set of parameter values is associated with a respective communication mode of the two or more communication modes. The method may include communicating, by the network node, with the UE based at least in part on the at least two sets of parameter values.

Some aspects described herein relate to a method of wireless communication performed by an apparatus at a UE. The method may include receiving, by the UE and from a network node, configuration information associated with two or more communication modes, of a plurality of communication modes, the two or more communication modes comprising at least one FD mode. The method may include communicating, by the UE, with the network node, in association with a first communication mode of the two or more communication modes. The method may include communicating, by the UE and associated with a mode transition condition, with the network node in association with a second communication mode of the two or more communication modes, wherein the mode transition condition is associated with a maximum number of transition points during a specified time period.

Some aspects described herein relate to a method of wireless communication performed by an apparatus at a network node. The method may include transmitting, by the network node and to a UE, configuration information associated with two or more communication modes, of a plurality of communication modes, the two or more communication modes comprising at least one FD mode. The method may include communicating, by the network node, with the UE in association with a first communication mode of the two or more communication modes. The method may include communicating, by the network node and associated with a mode transition condition, with the UE in association with a second communication mode of the two or more communication modes, wherein the mode transition condition is associated with a maximum number of transition points during a specified time period.

Some aspects described herein relate to a non-transitory computer-readable medium that stores a set of instructions for wireless communication by a UE. The set of instructions, when executed by one or more processors of the UE, may cause the UE to transmit, to a network node, capability information associated with two or more communication modes of a plurality of communication modes, the two or more communication modes comprising at least one FD mode. The set of instructions, when executed by one or more processors of the UE, may cause the UE to receive, from the network node, configuration information associated with the two or more communication modes, the configuration information indicating at least two sets of parameter values, wherein each set of parameter values is associated with a respective communication mode of the two or more communication modes. The set of instructions, when executed by one or more processors of the UE, may cause the UE to communicate with the network node based at least in part on the at least two sets of parameter values.

Some aspects described herein relate to a non-transitory computer-readable medium that stores a set of instructions for wireless communication by a network node. The set of instructions, when executed by one or more processors of the network node, may cause the network node to receive, from a UE, capability information associated with two or more communication modes of a plurality of communication modes, the two or more communication modes comprising at least one FD mode. The set of instructions, when executed by one or more processors of the network node, may cause the network node to transmit, to the UE, configuration information associated with the two or more communication modes, the configuration information indicating at least two sets of parameter values, wherein each set of parameter values is associated with a respective communication mode of the two or more communication modes. The set of instructions, when executed by one or more processors of the network node, may cause the network node to communicate with the UE based at least in part on the at least two sets of parameter values.

Some aspects described herein relate to a non-transitory computer-readable medium that stores a set of instructions for wireless communication by an UE. The set of instructions, when executed by one or more processors of the UE, may cause the UE to receive, from a network node, configuration information associated with two or more communication modes, of a plurality of communication modes, the two or more communication modes comprising at least one FD mode. The set of instructions, when executed by one or more processors of the UE, may cause the UE to communicate with the network node, in association with a first communication mode of the two or more communication modes. The set of instructions, when executed by one or more processors of the UE, may cause the UE to communicate, associated with a mode transition condition, with the network node in association with a second communication mode of the two or more communication modes, wherein the mode transition condition is associated with a maximum number of transition points during a specified time period.

Some aspects described herein relate to a non-transitory computer-readable medium that stores a set of instructions for wireless communication by a network node. The set of instructions, when executed by one or more processors of the network node, may cause the network node to transmit, to a UE, configuration information associated with two or more communication modes, of a plurality of communication modes, the two or more communication modes comprising at least one FD mode. The set of instructions, when executed by one or more processors of the network node, may cause the network node to communicate with the UE in association with a first communication mode of the two or more communication modes. The set of instructions, when executed by one or more processors of the network node, may cause the network node to communicate, associated with a mode transition condition, with the UE in association with a second communication mode of the two or more communication modes, wherein the mode transition condition is associated with a maximum number of transition points during a specified time period.

Some aspects described herein relate to an apparatus for wireless communication. The apparatus may include means for transmitting, to a network node, capability information associated with two or more communication modes of a plurality of communication modes, the two or more communication modes comprising at least one FD mode. The apparatus may include means for receiving, from the network node, configuration information associated with the two or more communication modes, the configuration information indicating at least two sets of parameter values, wherein each set of parameter values is associated with a respective communication mode of the two or more communication modes. The apparatus may include means for communicating with the network node based at least in part on the at least two sets of parameter values.

Some aspects described herein relate to an apparatus for wireless communication. The apparatus may include means for receiving, from a UE, capability information associated with two or more communication modes of a plurality of communication modes, the two or more communication modes comprising at least one FD mode. The apparatus may include means for transmitting, to the UE, configuration information associated with the two or more communication modes, the configuration information indicating at least two sets of parameter values, wherein each set of parameter values is associated with a respective communication mode of the two or more communication modes. The apparatus may include means for communicating with the UE based at least in part on the at least two sets of parameter values.

Some aspects described herein relate to an apparatus for wireless communication. The apparatus may include means for receiving, from a network node, configuration information associated with two or more communication modes, of a plurality of communication modes, the two or more communication modes comprising at least one FD mode. The apparatus may include means for communicating with the network node, in association with a first communication mode of the two or more communication modes. The apparatus may include means for communicating, associated with a mode transition condition, with the network node in association with a second communication mode of the two or more communication modes, wherein the mode transition condition is associated with a maximum number of transition points during a specified time period.

Some aspects described herein relate to an apparatus for wireless communication. The apparatus may include means for transmitting, to a UE, configuration information associated with two or more communication modes, of a plurality of communication modes, the two or more communication modes comprising at least one FD mode. The apparatus may include means for communicating with the UE in association with a first communication mode of the two or more communication modes. The apparatus may include means for communicating, associated with a mode transition condition, with the UE in association with a second communication mode of the two or more communication modes, wherein the mode transition condition is associated with a maximum number of transition points during a specified time period.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4A-4C are diagrams illustrating examples of full duplex (FD) communication in accordance with the present disclosure.

FIG. 5 is a diagram illustrating examples of FD communication in a wireless network, in accordance with the present disclosure.

FIG. 6 is a diagram illustrating an example of subband FD (SBFD) activation, in accordance with the present disclosure.

FIGS. 7A-7D are diagrams illustrating examples of various communication modes in accordance with the present disclosure.

FIG. 8 is a diagram illustrating an example associated with parameter sets for UE communication modes, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIG. 11 is a diagram illustrating an example process performed, for example, at a UE or an apparatus of a UE, in accordance with the present disclosure.

FIG. 12 is a diagram illustrating an example process performed, for example, at a network node or an apparatus of a network node, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

“Full duplex (FD) communication” in a wireless network refers to simultaneous bi-directional communication between devices in the wireless network. For example, a user equipment (UE) operating in an FD mode may transmit an uplink communication and receive a downlink communication at the same time (e.g., in the same slot or the same symbol). “Half duplex (HD) communication” in a wireless network refers to unidirectional communications (e.g., only downlink communication or only uplink communication) between devices at a given time (e.g., in a given slot or a given symbol). Subband full duplex (SBFD) is an FD mode in which a device (e.g., a UE) may transmit a communication and receive a communication at the same time, but on different frequency resources.

In some cases, a UE capable of FD and/or SBFD may be configured to communicate with one or more network nodes, cells, and/or transmission reception points (TRPs) capable of SBFD to further enhance system capacity, UL coverage, and to reduce latency. In other cases, an SBFD UE can communicate with two HD cells and/or TRPs (e.g., some cells with low capability could still implement in an HD cell mode). In some cases, two or more communication modes can be implemented in different time periods. A time period can be any period of time such as, for example, a symbol or a slot. To facilitate flexibility and efficiency in resource allocation and power consumption from the perspective of the UE and/or the network node, being able to transition between communication modes may be useful.

Some aspects of the techniques and apparatuses described herein may include configuring different parameter sets for different communication modes at a UE. For example, in some cases, a UE may be configured with two or more sets of parameter values associated with two or more communication modes. For example, a first set of parameter values may be associated with a first communication mode and a second set of parameter values may be associated with a second communication mode. A set of parameter values may be said to be associated with a communication mode if the set of parameter values can be used by a UE and/or a network node to communicate in accordance with the communication mode. In this way, some aspects may facilitate transitioning a UE between communication modes for different time periods, thereby enhancing flexibility of configuration of HD and/or FD communications between one or more UEs and one or more network nodes, allowing for improved network efficiency of resource allocation and/or improved device efficiency in terms of power consumption.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

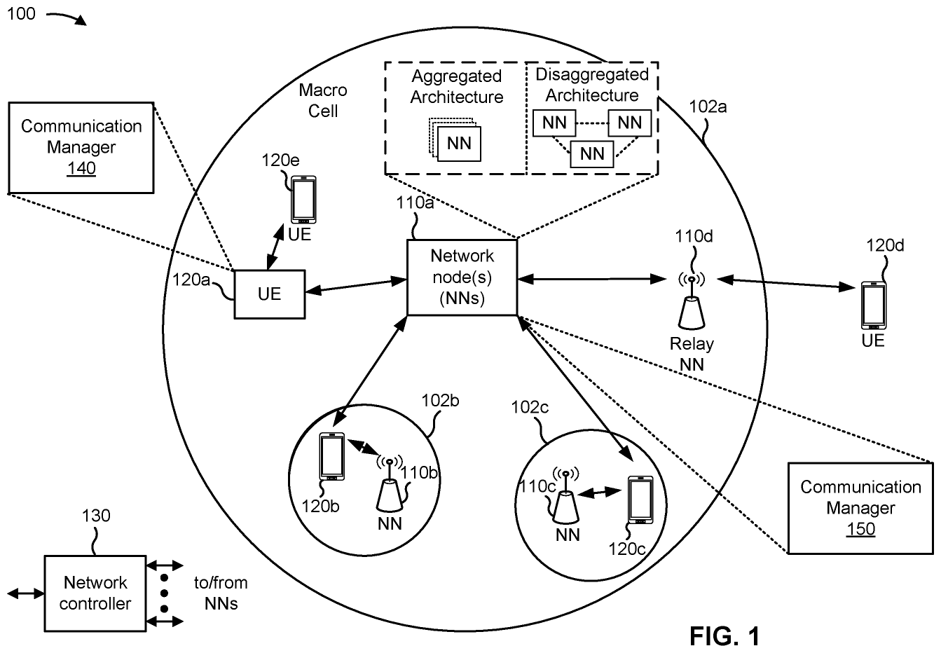

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may transmit, to a network node, capability information associated with two or more communication modes of a plurality of communication modes, the two or more communication modes comprising at least one FD mode; receive, from the network node, configuration information associated with the two or more communication modes, the configuration information indicating at least two sets of parameter values, wherein each set of parameter values is associated with a respective communication mode of the two or more communication modes; and communicate with the network node based at least in part on the at least two sets of parameter values.

In some aspects, the communication manager 140 may receive, from a network node, configuration information associated with two or more communication modes, of a plurality of communication modes, the two or more communication modes comprising at least one FD mode; communicate with the network node, in association with a first communication mode of the two or more communication modes; and communicate, associated with a mode transition condition, with the network node in association with a second communication mode of the two or more communication modes, wherein the mode transition condition is associated with a maximum number of transition points during a specified time period. Additionally, or alternatively, the communication manager 140 may perform one or more other operations described herein.

In some aspects, a network node (e.g., the network node 110) may include a communication manager 150. As described in more detail elsewhere herein, the communication manager 150 may receive, from a UE, capability information associated with two or more communication modes of a plurality of communication modes, the two or more communication modes comprising at least one FD mode; transmit, to the UE, configuration information associated with the two or more communication modes, the configuration information indicating at least two sets of parameter values, wherein each set of parameter values is associated with a respective communication mode of the two or more communication modes; and communicate with the UE based at least in part on the at least two sets of parameter values.

In some aspects, the communication manager 150 may transmit, to a UE, configuration information associated with two or more communication modes, of a plurality of communication modes, the two or more communication modes comprising at least one FD mode; communicate with the UE in association with a first communication mode of the two or more communication modes; and communicate, associated with a mode transition condition, with the UE in association with a second communication mode of the two or more communication modes, wherein the mode transition condition is associated with a maximum number of transition points during a specified time period. Additionally, or alternatively, the communication manager 150 may perform one or more other operations described herein.

As indicated above, FIG. 1 is provided as an example. Other examples may differ from what is described with regard to FIG. 1.

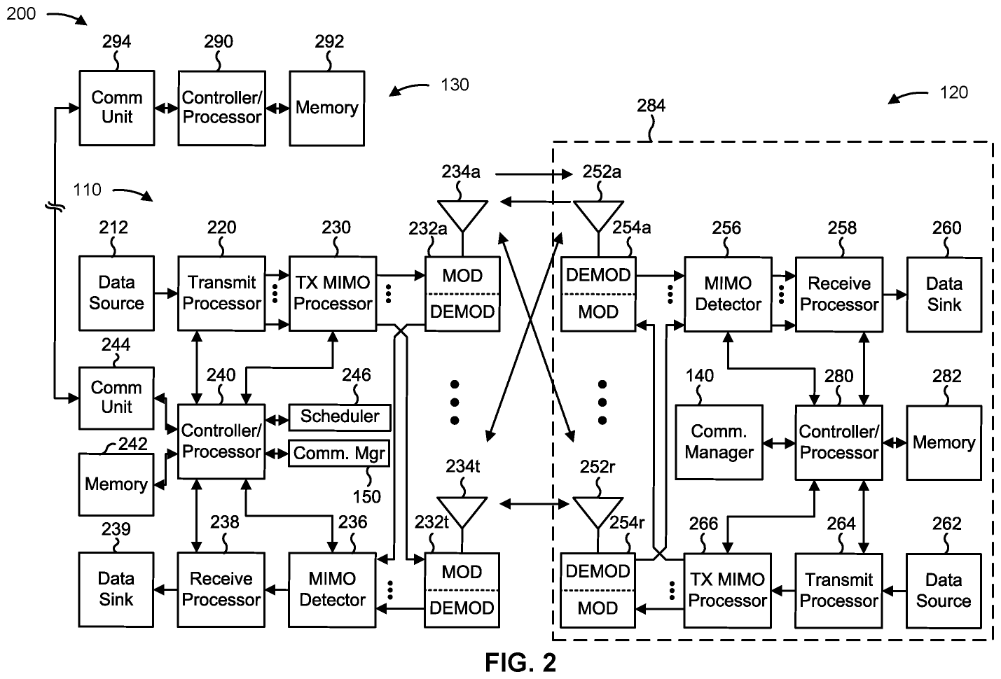

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing May provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type. A QCL type may indicate one or more spatial parameters to be derived from the source signal. The source signal may be referred to as a QCL source. The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a QCL type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

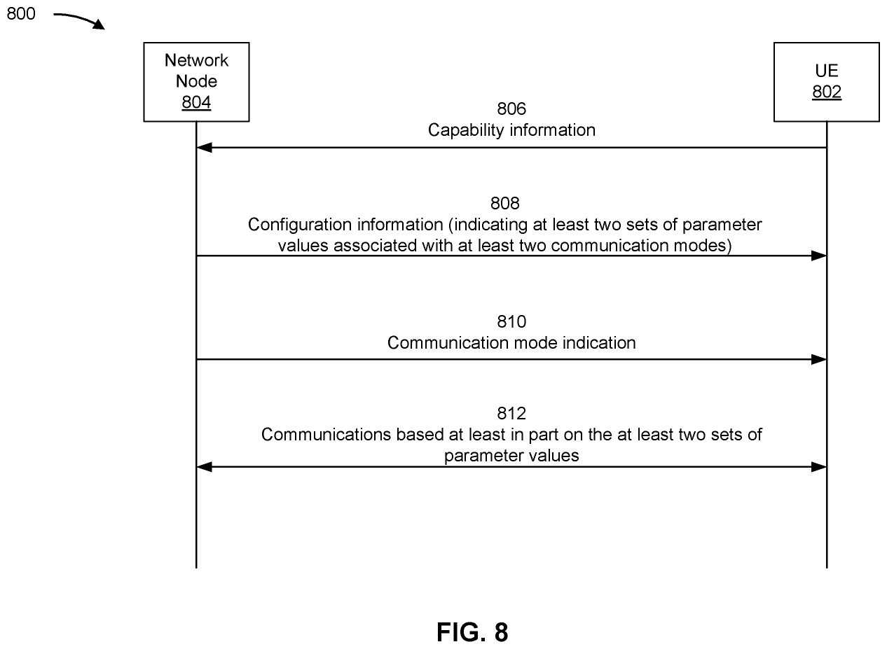

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-14).

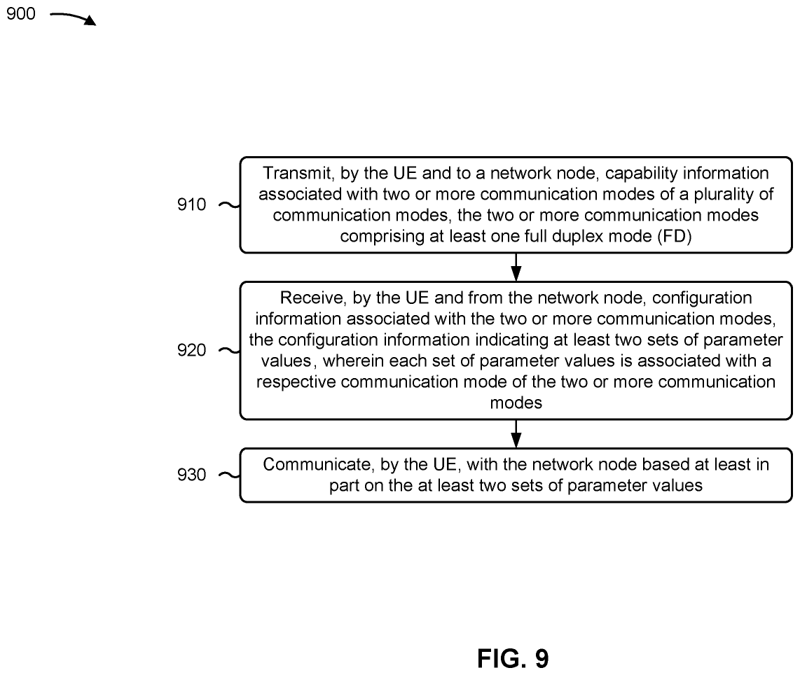

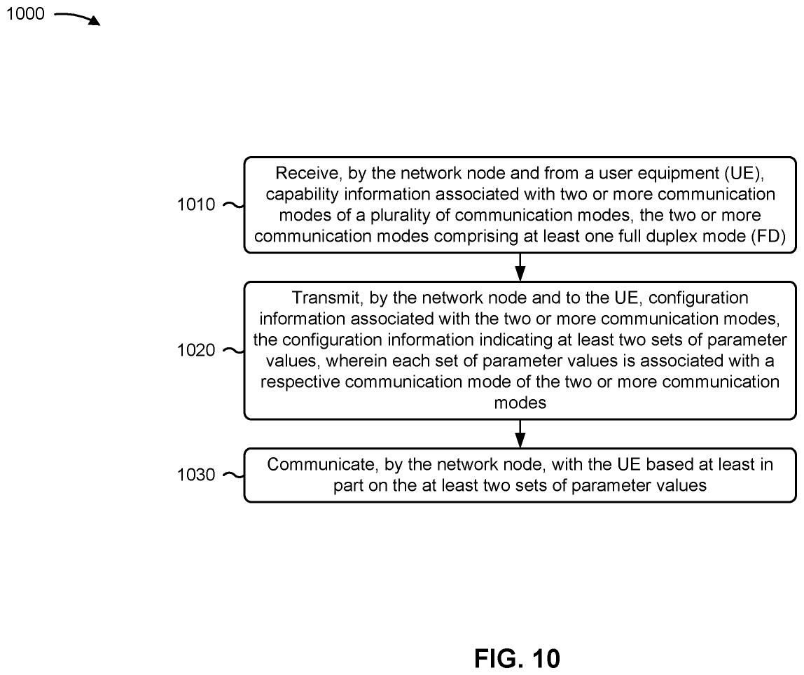

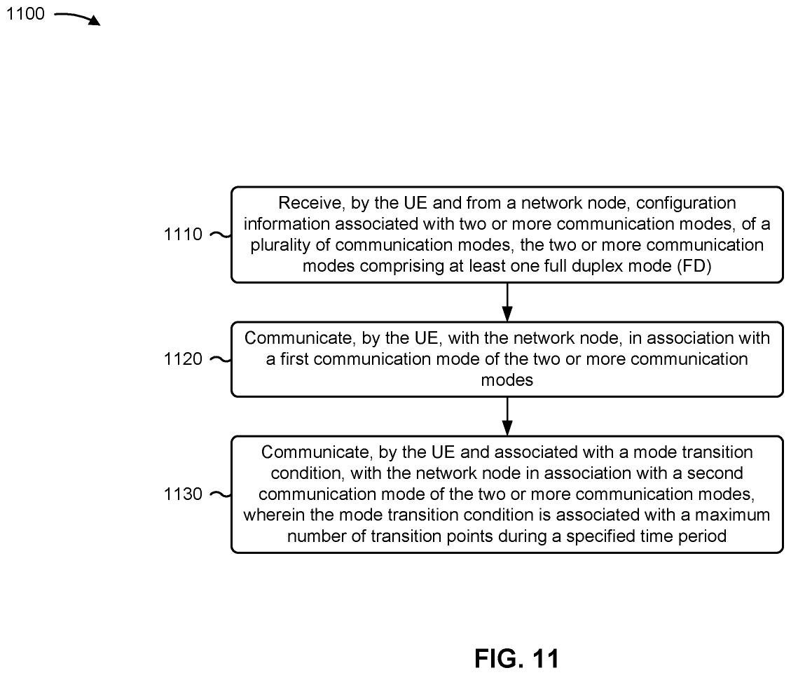

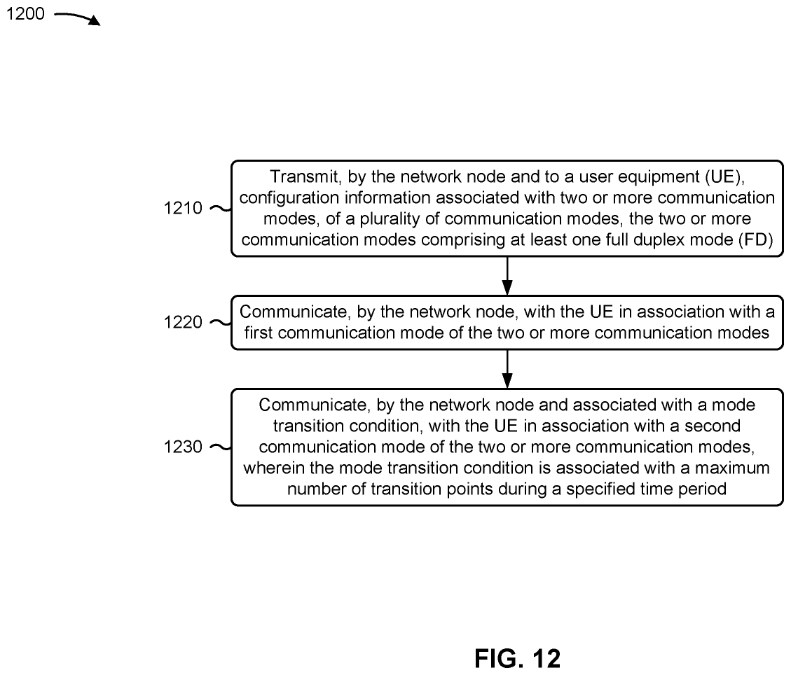

The controller/processor 240 of the network node 110, the controller/processor 280 of the UE 120, and/or any other component(s) of FIG. 2 may perform one or more techniques associated with parameter sets for UE communication modes, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, a UE (e.g., the UE 120) includes means for transmitting, by the UE and to a network node, capability information associated with two or more communication modes of a plurality of communication modes, the two or more communication modes comprising at least one FD mode; means for receiving, by the UE and from the network node, configuration information associated with the two or more communication modes, the configuration information indicating at least two sets of parameter values, wherein each set of parameter values is associated with a respective communication mode of the two or more communication modes; and/or means for communicating, by the UE, with the network node based at least in part on the at least two sets of parameter values.

In some aspects, the UE includes means for receiving, by the UE and from a network node, configuration information associated with two or more communication modes, of a plurality of communication modes, the two or more communication modes comprising at least one FD mode; means for communicating, by the UE, with the network node, in association with a first communication mode of the two or more communication modes; and/or means for communicating, by the UE and associated with a mode transition condition, with the network node in association with a second communication mode of the two or more communication modes, wherein the mode transition condition is associated with a maximum number of transition points during a specified time period. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for receiving, by the network node and from a UE, capability information associated with two or more communication modes of a plurality of communication modes, the two or more communication modes comprising at least one FD mode; means for transmitting, by the network node and to the UE, configuration information associated with the two or more communication modes, the configuration information indicating at least two sets of parameter values, wherein each set of parameter values is associated with a respective communication mode of the two or more communication modes; and/or means for communicating, by the network node, with the UE based at least in part on the at least two sets of parameter values. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the network node includes means for transmitting, by the network node and to a UE, configuration information associated with two or more communication modes, of a plurality of communication modes, the two or more communication modes comprising at least one FD mode; means for communicating, by the network node, with the UE in association with a first communication mode of the two or more communication modes; and/or means for communicating, by the network node and associated with a mode transition condition, with the UE in association with a second communication mode of the two or more communication modes, wherein the mode transition condition is associated with a maximum number of transition points during a specified time period. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

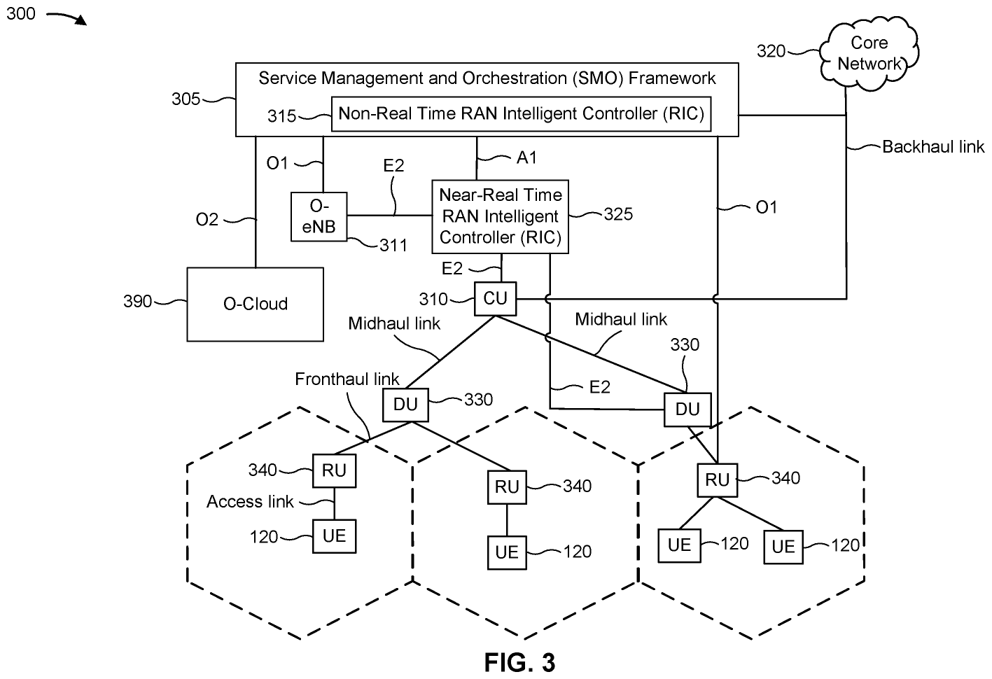

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

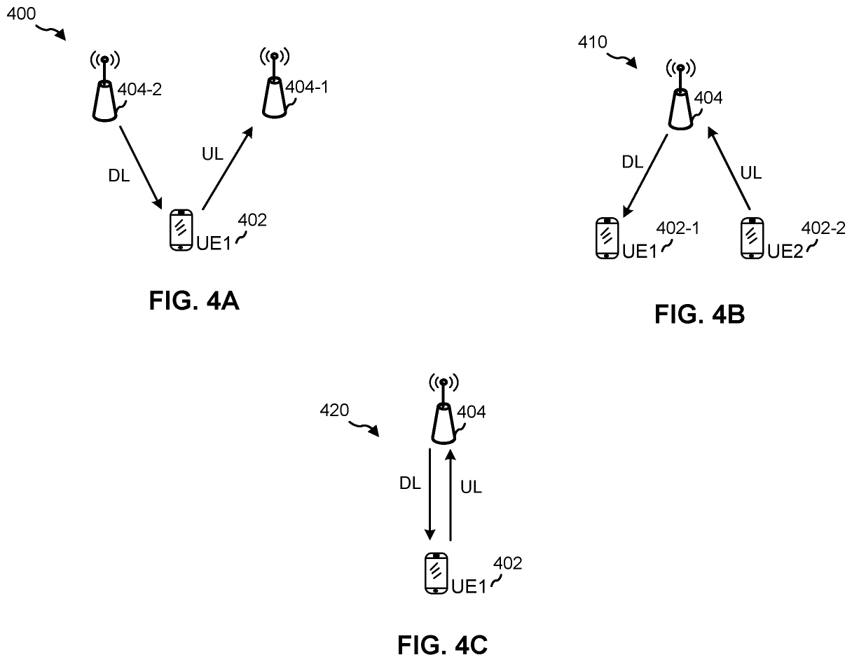

FIGS. 4A-4C are diagrams illustrating examples 400, 410, 420 of FD communication in accordance with the present disclosure. The example 400 of FIG. 4A includes a UE1 402 and two network nodes (e.g., transmission reception points (TRPs)) 404-1, 404-2, where the UE1 402 is sending UL transmissions to the network node 404-1 and is receiving DL transmissions from the network node 404-2. In the example 400 of FIG. 4A, FD is enabled for the UE1 402, but not for the network nodes 404-1, 404-2. The example 410 of FIG. 4B includes two UEs, shown as UE1 402-1 and UE2 402-2, and a network node 404, where the UE1 402-1 is receiving a DL transmission from the network node 404 and the UE2 402-2 is transmitting an UL transmission to the network node 404. In the example 410 of FIG. 4B, FD is enabled for the network node 404, but not for the UE1 402-1 and the UE2 402-2. The example 420 of FIG. 4C includes a UE1 402 and a network node 404, where the UE1 402 is receiving a DL transmission from the network node 404 and the UE1 402 is transmitting an UL transmission to the network node 404. In the example 420 of FIG. 4C, FD is enabled for both the UE1 402 and the network node 404.

As indicated above, FIGS. 4A-4C are provided as one or more examples. Other examples may differ from what is described with regard to FIGS. 4A-4C.

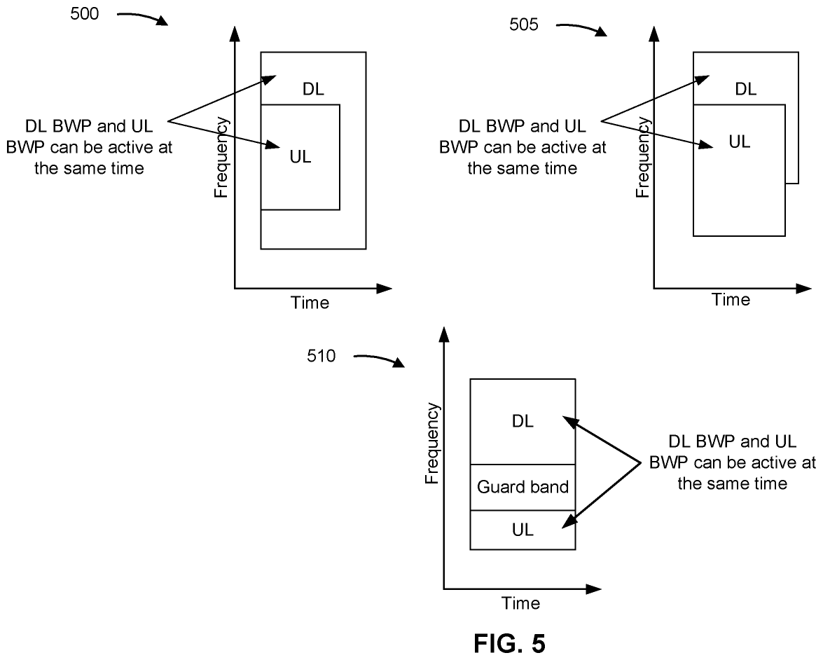

FIG. 5 is a diagram illustrating examples 500, 505, and 510 of FD communication in a wireless network, in accordance with the present disclosure. As shown in FIG. 5, examples 500 and 505 show examples of in-band full-duplex (IBFD) communication (which may also be referred to herein as “full duplex” (FD) communication). In FD, a UE may transmit an uplink communication to a network node and receive a downlink communication from the network node on the same time and frequency resources. As shown in example 500, in a first example of FD (referred to as “fully overlapping FD”), the time and frequency resources for uplink communication may fully overlap with the time and frequency resources for downlink communication. As shown in example 505, in a second example of FD (referred to as “partially overlapping FD”), the time and frequency resources for uplink communication may partially overlap with the time and frequency resources for downlink communication.

As further shown in FIG. 5, example 510 shows an example of SBFD communication, which may also be referred to as “sub-band frequency division duplex (SBFDD)” or “flexible duplex.” In SBFD, a UE may transmit an uplink communication to a network node and receive a downlink communication from the network node at the same time, but on different frequency resources. For example, the different frequency resources may be sub-bands of a frequency band, such as a time division duplexing (TDD) band. In this case, the frequency resources used for downlink communication may be separated from the frequency resources used for uplink communication, in the frequency domain, by a guard band.

As indicated above, FIG. 5 is provided as an example. Other examples may differ from what is described with respect to FIG. 5.

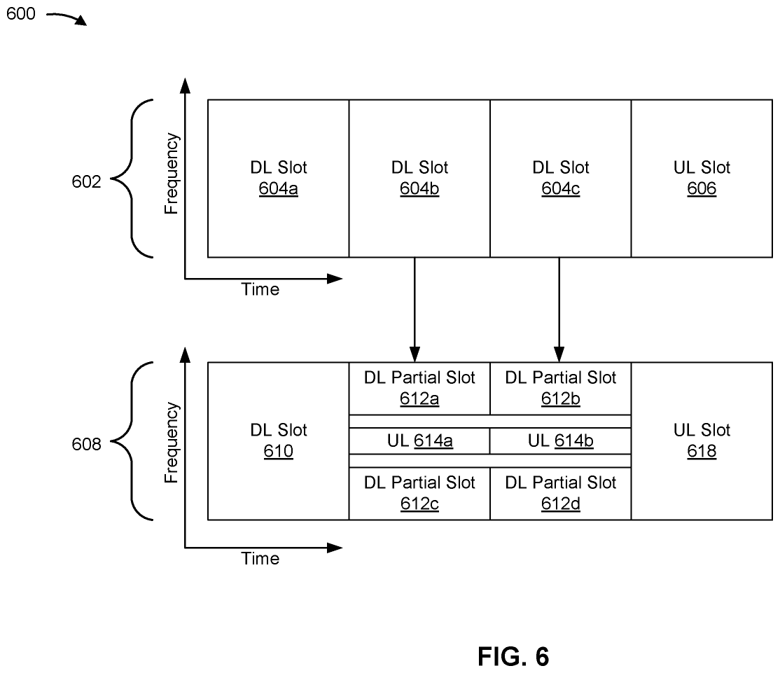

FIG. 6 is a diagram illustrating an example 600 of SBFD activation, in accordance with the present disclosure. As shown in FIG. 6, example 600 includes a first configuration 602. In some aspects, the first configuration 602 may indicate a first slot format pattern (sometimes called a TDD pattern) associated with a half-duplex mode or an FD mode. The first slot format pattern may include a quantity of downlink slots (e.g., three downlink slots 604a, 604b, and 604c, as shown), a quantity of flexible slots (not shown), and/or a quantity of uplink slots (e.g., one uplink slot 606, as shown). The first slot format pattern may repeat over time. In some aspects, a network node 110 may indicate the first slot format pattern to a UE 120 using one or more slot format indicators. A slot format indicator, for a slot, may indicate whether that slot is an uplink slot, a downlink slot, or a flexible slot, among other examples.

A network node 110 may instruct (e.g., using an indication, such as an RRC message, a MAC control element MAC-CE, or downlink control information (DCI)) a UE 120 to switch from the first configuration 602 to a second configuration 608. As an alternative, the UE 120 may indicate to the network node 110 that the UE 120 is switching from the first configuration 602 to the second configuration 608. The second configuration 608 may indicate a second slot format pattern that repeats over time, similar to the first slot format pattern. In any of the aspects described above, the UE 120 may switch from the first configuration 602 to the second configuration 608 during a time period (e.g., a quantity of symbols and/or an amount of time (e.g., in ms)) based at least in part on an indication received from the network node 110 (e.g., before switching back to the first configuration 602). During that time period, the UE 120 may communicate using the second slot format pattern, and then may revert to using the first slot format pattern after the end of the time period. The time period may be indicated by the network node 110 (e.g., in the instruction to switch from the first configuration 602 to the second configuration 608, as described above) and/or based at least in part on a programmed and/or otherwise preconfigured rule. For example, the rule may be based at least in part on a table (e.g., defined in 3GPP specifications and/or another wireless communication standard) that associates different sub-carrier spacings (SCSs) and/or numerologies (e.g., represented by u and associated with corresponding SCSs) with corresponding time periods for switching configurations.

In example 600, the second slot format pattern includes a downlink slot 610, an uplink slot 618, and two SBFD slots in place of what were downlink slots in the first slot format pattern. In example 600, each SBFD slot includes a partial slot (e.g., a portion or sub-band of a frequency allocated for use by the network node 110 and the UE 120) for downlink (e.g., partial slots 612a, 612b, 612c, and 612d, as shown) and a partial slot for uplink (e.g., partial slots 614a and 614b, as shown). Accordingly, the UE 120 may operate using the second slot format pattern to transmit an uplink communication in an earlier slot (e.g., the second slot in sequence, shown as partial UL slot 614a) as compared to using the first slot format pattern (e.g., the fourth slot in sequence, shown as UL slot 606). Other examples may include additional or alternative changes. For example, the second configuration 608 may indicate an SBFD slot in place of what was an uplink slot in the first configuration 602 (e.g., UL slot 606). In another example, the second configuration 608 may indicate a downlink slot or an uplink slot in place of what was an SBFD slot in the first configuration 602 (not shown in FIG. 6). In yet another example, the second configuration 608 may indicate a downlink slot or an uplink slot in place of what was an uplink slot or a downlink slot, respectively, in the first configuration 602. An “SBFD slot” may refer to a slot in which an SBFD format is used. An SBFD format may include a slot format in which FD communication is supported (e.g., for both uplink and downlink communications), with one or more frequencies used for an uplink portion of the slot being separated from one or more frequencies used for a downlink portion of the slot by a guard band. In some examples, the SBFD format may include a single uplink portion and a single downlink portion separated by a guard band. In some examples, the SBFD format may include multiple downlink portions and a single uplink portion that is separated from the multiple downlink portions by respective guard bands (e.g., as shown in FIG. 6). In some examples, an SBFD format may include multiple uplink portions and a single downlink portion that is separated from the multiple uplink portions by respective guard bands. In some examples, the SBFD format may include multiple uplink portions and multiple downlink portions, where each uplink portion is separated from a downlink portion by a guard band. In some examples, operating using an SBFD mode may include activating or using an FD mode in one or more slots based at least in part on the one or more slots having the SBFD format. A slot may support the SBFD mode if an uplink bandwidth part (BWP) and a downlink BWP are permitted to be or are simultaneously active in the slot in an SBFD fashion (e.g., with guard band separation).

By switching from the first configuration 602 to the second configuration 608, the network node 110 and the UE 120 may experience increased quality and/or reliability of communications. For example, the network node 110 and the UE 120 may experience increased throughput (e.g., using an FD mode), reduced latency (e.g., the UE 120 may be able to transmit an uplink and/or receive a downlink communication sooner using the second configuration 608 rather than the first configuration 602), and increased network resource utilization (e.g., by using both the downlink BWP and the uplink BWP simultaneously instead of only the downlink BWP or the uplink BWP).

As indicated above, FIG. 6 is provided as an example. Other examples may differ from what is described with respect to FIG. 6.

In some cases, a UE capable of FD and/or SBFD may be configured to communicate with one or more network nodes, cells, and/or TRPs capable of SBFD to further enhance system capacity, UL coverage, and to reduce latency. In other cases, an SBFD UE can communicate with two half duplex (HD) cells and/or TRPs (e.g., some cells with low capability could still implement in an HD cell mode). In some cases, two or more communication modes can be implemented in different time periods. To facilitate flexibility and efficiency in resource allocation and power consumption from the perspective of the UE and/or the network node, being able to transition between communication modes may be useful.

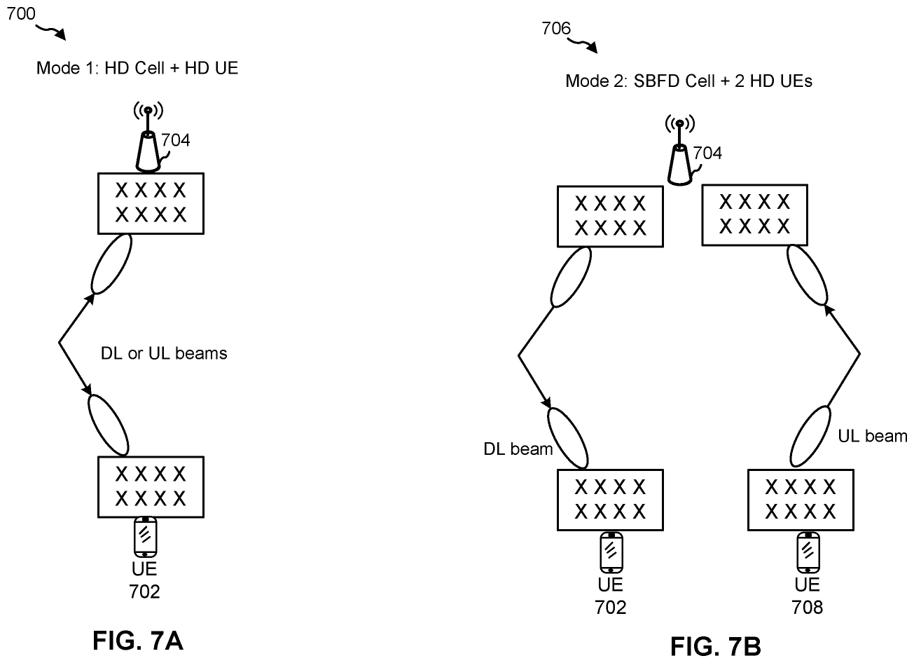

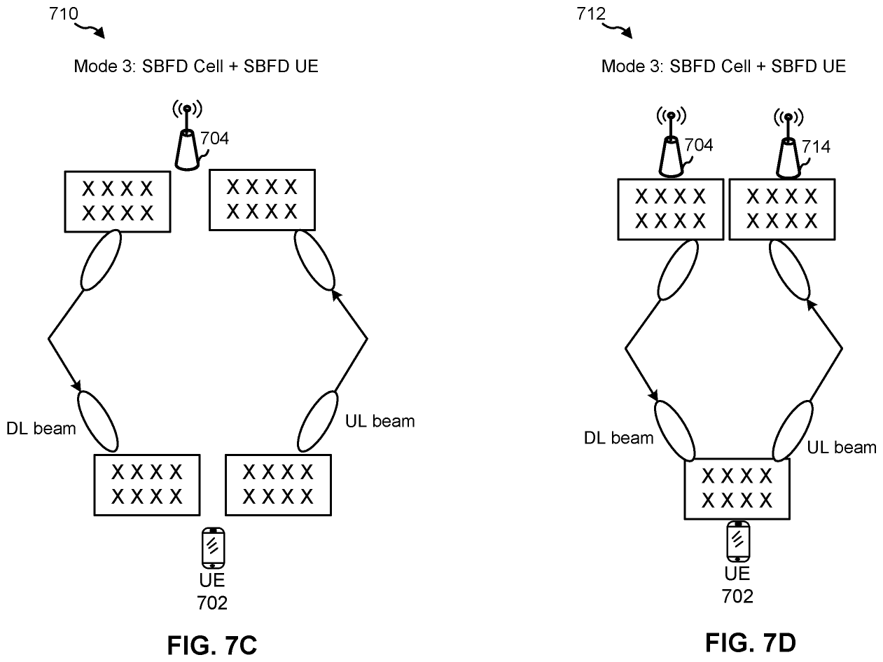

FIGS. 7A-7D are diagrams illustrating examples of various communication modes in accordance with the present disclosure. FIG. 7A illustrates an example 700 of a first communication mode (“Mode 1”) in which an HD UE 702 communicates with a network node 704 that provides an HD cell. In a time period, either the UE 702 may receive a communication from the network node 704 or transmit a communication to the network node 704. FIG. 7B illustrates an example 706 of a second communication mode (“Mode 2”) in which a network node 704 provides an SBFD cell that communicates with two HD UEs 702 and 708. In a time period, the UE 702 may receive a communication from the network node 704 simultaneously with the UE 708 transmitting a communication to the network node 704.

FIG. 7C illustrates an example 710 of a third communication mode (“Mode 3”) in which an SBFD UE 702 communicates with a network node 704 that provides an SBFD cell. During a time period, the UE 702 may simultaneously transmit (e.g., via an UL subband) a communication to the network node 704 and receive (e.g., via a DL subband) a communication from the network node 704. FIG. 7D illustrates an example 712 of a fourth communication mode (“Mode 4”) in which an SBFD UE 702 communicates with one or more network nodes 704, 714 via two HD cells and/or HD TRPs, respectively. During a time period, the UE 702 may receive a communication from the first TRP 704 (and/or via the first cell) and transmit a communication to the second TRP 714 (and/or via the second cell). In some cases, a fifth communication mode (“Mode 5”) may be implemented in which an FD UE communicates with one or more TRPs and/or via one or more cells. The FD UE may be configured for partially overlapping FD and/or fully overlapping FD.

Some aspects of the techniques and apparatuses described herein may include configuring different parameter value sets for different communication modes at a UE. For example, in some cases, a UE may be configured with two or more sets of parameter values associated with two or more communication modes. For example, a first set of parameter may be associated with a first communication mode and a second set of parameter values may be associated with a second communication mode. A set of parameter values may be said to be associated with a communication mode if the set of parameter values can be used by a UE and/or a network node to communicate in accordance with the communication mode. In this way, some aspects may facilitate transitioning a UE between communication modes for different time periods, thereby enhancing flexibility of configuration of HD and/or FD communications between one or more UEs and one or more network nodes, allowing for improved network efficiency of resource allocation and/or improved device efficiency in terms of power consumption.

As indicated above, FIGS. 7A-7D are provided as examples. Other examples may differ from what is described with respect to FIGS. 7A-7D.

FIG. 8 is a diagram illustrating an example 800 associated with parameter sets for UE communication modes, in accordance with the present disclosure. As shown in FIG. 8, a UE 802 and a network node 804 may communicate with one another. In some aspects, the UE 802 may be, be similar to, include, or be included in, the UE 702 and/or the UE 708 depicted in FIGS. 7A-7D; the UE1 402, the UE1 402-1, and/or the UE2 402-2 depicted in FIGS. 4A-4C; and/or the UE 120 depicted in FIGS. 1-3. In some aspects, the network node 804 may be, be similar to, include, or be included in, the TRP 704 and/or the TRP 714 depicted in FIGS. 7A-7D; the TRP 404, the TRP 404-1, and/or the TRP 404-2 depicted in FIGS. 4A-4C; the network node 110 depicted in FIGS. 1 and 2; and/or one or more components of the disaggregated base station architecture 300 depicted in FIG. 3.

As shown by reference number 806, the UE 802 may transmit, and the network node 804 may receive, capability information. In some aspects, the capability information may be associated with two or more communication modes of a plurality of communication modes. The two or more communication modes may include at least one FD mode. The at least one FD mode may include at least one of an SBFD mode, a partial overlapping FD mode, or a fully overlapping FD mode. In some aspects, the two or more communication modes may include a first mode (e.g., Mode 1) in which the UE 802 comprises an HD UE and the network node 804 provides an HD cell. In the first mode, the UE 802 may communicate with the network node 804 in association with one communication direction (e.g., uplink or downlink) during a time period (e.g., a symbol or a slot). The two or more communication modes may include a second mode (e.g., Mode 2) in which the UE 802 may include a first HD UE of a plurality of HD UEs and the network node 804 may provide an SBFD cell. In the second mode, the UE 802 may communicate with the network node 804 in association with one communication direction during the time period. The two or more communication modes may include a third mode (e.g., Mode 3) in which the UE 802 includes an SBFD UE and the network node 804 provides an SBFD cell. In the third mode, the UE 802 may communicate with the network node 804 in association with two communication directions during the time period. The two or more communication modes may include a fourth mode (e.g., Mode 4) in which the UE 802 may include an SBFD UE and the network node 804 may provide an HD cell or transmission reception point (TRP) of a plurality of HD cells. In the fourth mode, the UE 802 may communicate via the cell or the TRP in association with a first communication direction during the time period and via an additional cell or an additional TRP in association with a second communication direction during the time period. The two or more communication modes may include a fifth communication mode (e.g., Mode 5) in which the UE 802 may include a partially overlapping FD UE and/or a fully overlapping FD UE.

As shown by reference number 808, the network node 804 may transmit, and the UE 802 may receive, configuration information. In some aspects, the configuration information may be associated with the two or more communication modes. In some aspects, the configuration information may indicate at least two sets of parameter value. Each set of parameter values may be associated with a respective communication mode of the two or more communication modes. In some aspects, at least one parameter value of the at least two sets of parameter values may be associated with the two or more communication modes of the plurality of communication modes. In some aspects, a first parameter value of the at least two sets of parameter values may be associated with a first communication mode during a first time period of the plurality of communication modes and a second parameter value of the at least two sets of parameter values may be associated with a second communication mode during a second time period of the plurality of communication modes. The first time period May include at least one of a first set of symbols or a first set of slots, and the second time period may include at least one of a second set of symbols or a second set of slots.

In some aspects, each set of parameter values of the at least two sets of parameter values may indicate a spatial parameter, an uplink power control (PC) parameter, a modulation and coding scheme (MCS), an antenna configuration, a timing parameter, and/or an operation parameter, among other examples. The spatial parameter may be indicative of an antenna configuration, a TCI state, a downlink beam, an uplink beam, and/or a spatial relation, among other examples. In some aspects, the uplink PC parameter may be indicative of at least one of a P0 parameter, an alpha parameter, a closed loop index (CLI) parameter, and/or a pathloss reference signal (PL RS) parameter, among other examples. A P0 parameter may include an uplink PC parameter that represents a target received power (e.g., for a receiver of an uplink transmission). An alpha parameter may include an uplink PC parameter that represents a compensation factor (e.g., a pathloss compensation factor) in a power control formula for the transmission chain. The CLI parameter may include an uplink PC parameter that indicates a transmit power command (TCP) index that is to be applied to one or more closed power control loops in the transmission chain. In some aspects, the PL RS parameter may indicate an amount of pathloss (e.g., an amount of signal power lost during transmission to a network node 804). In some aspects, the PL RS parameter may indicate a resource that is to be measured by the UE 802 to perform power control for the transmission chain. For example, the PL RS parameter may indicate a reference signal that is to be measured for pathloss estimation and power control estimation for a corresponding uplink channel.

In some aspects, the timing parameter may be indicative of at least one of a transmission timing or a timing advance (TA). In some aspects, the operation parameter may be indicative of a rank indicator (RI), a precoding matrix indicator (PMI), a transmit precoder matrix indicator (TPMI), a demodulation reference signal (DMRS) format, a time domain resource allocation, a frequency domain resource allocation, a physical uplink control channel (PUCCH) configuration, and/or a precoding resource block group (PRG), among other examples.

In some aspects, one or more parameter values of the at least two sets of parameter values may be associated with a time period (e.g., a symbol or a slot). In some aspects, one or more parameter values of the at least two sets of parameter values may be associated with a bandwidth part (BWP), a downlink subband of an SBFD communication mode, and/or an uplink subband of the SBFD communication mode.

In some aspects, the network node 804 may configure multiple (two or three) separate parameters such as spatial parameters, UL PC parameters, MCS, timing, etc. for the UE 802 to apply on different symbols/slots based on the network node 804 indication of the operation mode. In some aspects, some communication modes may share one or more of the same operation parameters. As an example, Mode 3 and Mode 4 may share the same parameters for the UE 802. For example, an SBFD UE may use the same parameters regardless of whether the SBFD UE communicates with an SBFD network node 804 or with two HD TRPs. In some other cases, some modes may apply different operation parameters. For example, the UE 802 may have different antenna configurations for different communication modes. For example, the UE 804 may use a full antenna array for a cell/TRP SBFD+HD UE mode, whereas the UE 802 may split the full antenna array into two separate antenna arrays/panels for a UE SBFD/FD mode.

In some aspects, for an SBFD UE mode, the network node 804 may configure the UE 802 with two TCI states for paired DL and UL transmissions with limited self interference, which may be associated with different TCI states than an HD UE mode with a best reference signal received power (RSRP) beam. As described above, operation parameters may be different for different communication modes. In some aspects, for example, the UE 802 RF components may retune if the parameters are different for two different communication modes (e.g., if an additional UE filter is used for SBFD mode for self-interference mitigation). In some aspects, the UE 802 may apply a corresponding random access (RA)/physical uplink control channel (PUCCH)/operation parameter per occasion based on an indicated slot pattern (e.g., an HD/SBFD slot pattern). In some aspects, different RAs may better match available DL/UL BWPs and/or subbands, which may be different at least in HD and SBFD slots.

As shown by reference number 810, the network node 804 may transmit, and the UE 802 may receive, a communication mode indication. In some aspects, the communication mode indication may be indicative of an operation mode of the two or more communication modes.

Although transitions from one communication mode to another may be based on a network node configuration and/or implementation, the frequency of mode transitions may be limited based on any number of factors such as, for example, phase continuity; potential interruption of transmissions and/or receptions during transition; required guard times (if any) for transitioning; potential impacts on performance, impacts on link adaptation, channel estimation, and/or other procedures; UL transmission timing (if any); implementation complexity; and/or applicability for network node SBFD aware UEs, FD capable UEs versus non-gNB SBFD aware UEs, and/or non-FD capable UEs, among other examples. In some aspects, a wireless communication standard may include rules for defining a maximum number of transition points for transitioning between communication modes.

In some aspects, a maximum number of transition points may apply to a time period and may be associated with (e.g., determined based on) any number of factors such as, for example, an SBFD and/or FD capability (e.g., a dynamic capability) of the UE 802, an SBFD and/or FD capability of the network node 804, an overhead time, a guard time, an implementation complexity of the UE 802 and/or the network node 804 (e.g., with regard to RF retuning and/or filter changes).

For example, in some aspects, the communication mode indication may be associated with a mode transition condition. The mode transition condition may be associated with a maximum number of transition points during a specified time period. In some aspects, an indication of the maximum number of transition points may be maintained in one or more memories of the UE 802 (e.g., as a result of being specified in a wireless communication standard). In some aspects, the maximum number of transition points may be associated with a transition delay, a UE SBFD capability, a UE partially overlapping FD capability, a UE fully overlapping FD capability, a network node SBFD capability, a network node partially overlapping FD capability, a network node fully overlapping FD capability, an overhead timing for a mode transition, a guard time for the mode transition, a UE implementation complexity, and/or a network node implementation complexity, among other examples.

In some aspects, the maximum number of transition points may be associated with a time division duplexing (TDD) uplink/downlink slot format pattern period. In some aspects, the maximum number of transition points may be associated with a semi-static network node SBFD configuration period. The maximum number of transition points may be associated with a slot. For example, a transition point of the maximum number of transitions points may be aligned with a slot boundary or within a slot.

In some aspects, a number of transition points of the maximum number of transition points may be associated with a UE transition point capability. In some aspects, the capability information may indicate the UE transition point capability. In some aspects, the UE transition point capability may be indicative of one or more maximum numbers of transition points. The one or more maximum numbers of transition points may include a first maximum number of transition points associated with a first SCS and a second maximum number of transition points associated with a second SCS.

For example, in some aspects, the UE 802 may report one or more capabilities on a maximum number of transition points between two or more communication modes within a slot, within a TDD UL/DL pattern period, and/or within a semi-static network node SBFD configuration period per SCS. As an example, the UE 802 may report, as maximum numbers of transition points, N transition points between mode I and mode J within a slot on 30 KHz, and M transition points between mode I and mode J within a slot/within a TDD UL/DL pattern period/within a semi-static network node SBFD configuration period on 120 KHz. As another example, the UE 802 may report, as maximum numbers of transition points, N transition points between mode K and mode M within a slot/within a TDD UL/DL pattern period/within a semi-static network node SBFD configuration period on 30 KHz, and M switching points between mode K and mode M within a slot/within a TDD UL/DL pattern period/within a semi-static network node SBFD configuration period on 120 KHz.

In some aspects, the UE transition point capability may be indicative of only one reference maximum number of transition points for a frequency range. The one reference maximum number of transition points may be associated with a first SCS, and a maximum number of transition points associated with a second SCS of the frequency range may include a scaled value associated with the one reference maximum number of transition points. For example, in some aspects, the UE 802 may only report one reference capability on a maximum number of transition points between two or more communication modes within a slot/within a TDD UL/DL pattern period/within a semi-static network node SBFD configuration period per FR. As an example, the UE 802 may report S1 switching points between mode I and mode J within a slot/within a TDD UL/DL pattern period/within a semi-static network node SBFD configuration period on 60 KHz. The UE 802 may scale that number for other SCSs for FR2. For example, in some aspects, reporting the reference maximum number of transition points may imply S1/2 switching points between mode I and mode J within a slot/within a TDD UL/DL pattern period/within a semi-static network node SBFD configuration period on 120 KHz. As another example, the UE 802 may report S2 transition points between mode I and mode J within a slot/within a TDD UL/DL pattern period/within a semi-static network node SBFD configuration period on 15 KHz, and then scale for other SCSs for FR1 (e.g., implying a maximum of S2/2 transition points between mode I and mode J within a slot/within a TDD UL/DL pattern period/within a semi-static network node SBFD configuration period on 30 KHz). In some aspects, the maximum number of transition points may be specified by a wireless communication standard, which may, for example, specify any number of the configurations described above (e.g., explicit specification of a maximum number of transition points for a time period and SCS, and/or specification of a reference maximum number of transition points, among other examples).

As shown by reference number 812, the UE 802 and the network node 804 may communicate based at least in part on the at least two sets of parameter values.

As indicated above, FIG. 8 is provided as an example. Other examples may differ from what is described with respect to FIG. 8.

FIG. 9 is a diagram illustrating an example process 900 performed, for example, at a UE or an apparatus of a UE, in accordance with the present disclosure. Example process 900 is an example where the apparatus or the UE (e.g., the UE 802) performs operations associated with parameter sets for UE communication modes.

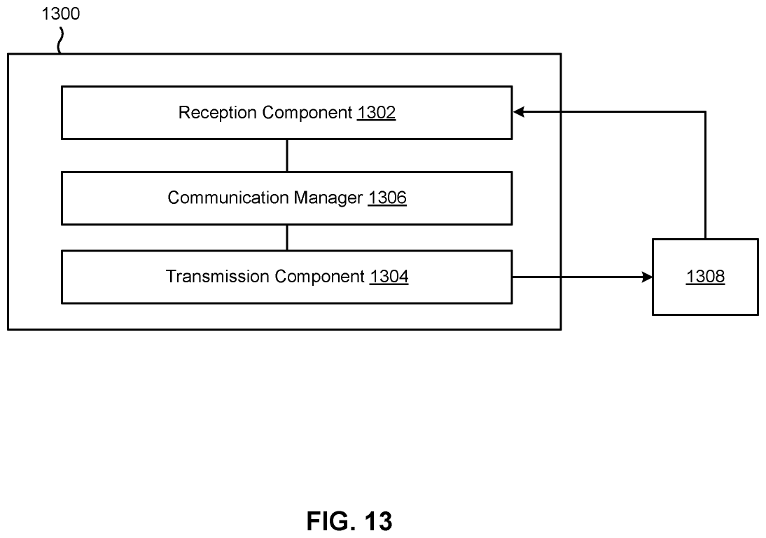

As shown in FIG. 9, in some aspects, process 900 may include transmitting, to a network node, capability information associated with two or more communication modes of a plurality of communication modes, the two or more communication modes comprising at least one FD mode (block 910). For example, the UE (e.g., using transmission component 1304 and/or communication manager 1306, depicted in FIG. 13) may transmit, to a network node, capability information associated with two or more communication modes of a plurality of communication modes, the two or more communication modes comprising at least one FD mode, as described above.

As further shown in FIG. 9, in some aspects, process 900 may include receiving, from the network node, configuration information associated with the two or more communication modes, the configuration information indicating at least two sets of parameter values, wherein each set of parameter values is associated with a respective communication mode of the two or more communication modes (block 920). For example, the UE (e.g., using reception component 1302 and/or communication manager 1306, depicted in FIG. 13) may receive, from the network node, configuration information associated with the two or more communication modes, the configuration information indicating at least two sets of parameter values, wherein each set of parameter values is associated with a respective communication mode of the two or more communication modes, as described above.

As further shown in FIG. 9, in some aspects, process 900 may include communicating with the network node based at least in part on the at least two sets of parameter values (block 930). For example, the UE (e.g., using reception component 1302, transmission component 1304, and/or communication manager 1306, depicted in FIG. 13) may communicate with the network node based at least in part on the at least two sets of parameter values, as described above.

Process 900 may include additional aspects, such as any single aspect or any combination of aspects described below and/or in connection with one or more other processes described elsewhere herein.

In a first aspect, each set of parameter values of the at least two sets of parameter values indicates at least one of a spatial parameter, an uplink power control parameter, a modulation and coding scheme, an antenna configuration, a timing parameter, or an operation parameter. In a second aspect, alone or in combination with the first aspect, the spatial parameter is indicative of at least one of an antenna configuration, a TCI state, a downlink beam, an uplink beam, or a spatial relation. In a third aspect, alone or in combination with one or more of the first and second aspects, the uplink power control parameter is indicative of at least one of a P0 parameter, an alpha parameter, a closed loop index parameter, or a PL RS parameter.

In a fourth aspect, alone or in combination with one or more of the first through third aspects, the timing parameter is indicative of at least one of a transmission timing or a TA. In a fifth aspect, alone or in combination with one or more of the first through fourth aspects, the operation parameter is indicative of at least one of an RI, a PMI, a TPMI, a DMRS format, a time domain resource allocation, a frequency domain resource allocation, a PUCCH configuration, or a PRG.

In a sixth aspect, alone or in combination with one or more of the first through fifth aspects, one or more parameter values of the at least two sets of parameter values is associated with a time period. In a seventh aspect, alone or in combination with one or more of the first through sixth aspects, the time period comprises at least one of a symbol or a slot. In an eighth aspect, alone or in combination with one or more of the first through seventh aspects, one or more parameter values of the at least two sets of parameter values is associated with at least one of a BWP, a downlink subband of an SBFD communication mode, or an uplink subband of the SBFD communication mode.

In a ninth aspect, alone or in combination with one or more of the first through eighth aspects, process 900 includes receiving, by the UE and from the network node, a communication mode indication indicative of an operation mode of the two or more communication modes, wherein communicating with the network node comprises communicating in association with the operation mode. In a tenth aspect, alone or in combination with one or more of the first through ninth aspects, the communication mode indication is associated with a mode transition condition. In an eleventh aspect, alone or in combination with one or more of the first through tenth aspects, the mode transition condition is associated with a maximum number of transition points during a specified time period. In a twelfth aspect, alone or in combination with one or more of the first through eleventh aspects, an indication of the maximum number of transition points is maintained in one or more memories of the UE.

In a thirteenth aspect, alone or in combination with one or more of the first through twelfth aspects, the maximum number of transition points is associated with at least one of a transition delay, a UE SBFD capability, a UE partially overlapping FD capability, a UE fully overlapping FD capability, a network node SBFD capability, a network node partially overlapping FD capability, a network node fully overlapping FD capability, an overhead timing for a mode transition, a guard time for the mode transition, a UE implementation complexity, or a network node implementation complexity. In a fourteenth aspect, alone or in combination with one or more of the first through thirteenth aspects, the maximum number of transition points is associated with a TDD uplink/downlink slot format pattern period. In a fifteenth aspect, alone or in combination with one or more of the first through fourteenth aspects, the maximum number of transition points is associated with a semi-static network node SBFD configuration period.

In a sixteenth aspect, alone or in combination with one or more of the first through fifteenth aspects, the maximum number of transition points is associated with a slot. In a seventeenth aspect, alone or in combination with one or more of the first through sixteenth aspects, a transition point of the maximum number of transitions points is aligned with a slot boundary. In an eighteenth aspect, alone or in combination with one or more of the first through seventeenth aspects, a transition point of the maximum number of transitions points is aligned within a slot.

In a nineteenth aspect, alone or in combination with one or more of the first through eighteenth aspects, a number of transition points of the maximum number of transition points are associated with a UE transition point capability. In a twentieth aspect, alone or in combination with one or more of the first through nineteenth aspects, the capability information indicates the UE transition point capability. In a twenty-first aspect, alone or in combination with one or more of the first through twentieth aspects, the UE transition point capability is indicative of one or more maximum numbers of transition points. In a twenty-second aspect, alone or in combination with one or more of the first through twenty-first aspects, the one or more maximum numbers of transition points comprises a first maximum number of transition points associated with a first SCS and a second maximum number of transition points associated with a second SCS. In a twenty-third aspect, alone or in combination with one or more of the first through twenty-second aspects, the UE transition point capability is indicative of only one reference maximum number of transition points for a frequency range.

In a twenty-fourth aspect, alone or in combination with one or more of the first through twenty-third aspects, the one reference maximum number of transition points is associated with a first SCS, and wherein a maximum number of transition points associated with a second SCS of the frequency range comprises a scaled value associated with the one reference maximum number of transition points. In a twenty-fifth aspect, alone or in combination with one or more of the first through twenty-fourth aspects, the at least one FD mode comprises at least one of an SBFD mode, a partial overlapping FD mode, or a fully overlapping FD mode.

In a twenty-sixth aspect, alone or in combination with one or more of the first through twenty-fifth aspects, the two or more communication modes comprise at least one of a first mode in which the UE comprises an HD UE and the network node provides an HD cell, wherein, in the first mode, the UE communicates with the network node in association with one communication direction during a time period, a second mode in which the UE comprises a first HD UE of a plurality of HD UEs and the network node provides an SBFD cell, wherein, in the second mode, the UE communicates with the network node in association with one communication direction during the time period, a third mode in which the UE comprises an SBFD UE and the network node provides an SBFD cell, wherein, in the third mode, the UE communicates with the network node in association with two communication directions during the time period, or a fourth mode in which the UE comprises an SBFD UE and the network node provides an HD cell or transmission reception point (TRP) of a plurality of HD cells, wherein, in the fourth mode, the UE communicates via the cell or the TRP in association with a first communication direction during the time period and via an additional cell or an additional TRP in association with a second communication direction during the time period.

In a twenty-seventh aspect, alone or in combination with one or more of the first through twenty-sixth aspects, at least one parameter value of the at least two sets of parameter values is associated with the two or more communication modes of the plurality of communication modes. In a twenty-eighth aspect, alone or in combination with one or more of the first through twenty-seventh aspects, a first parameter value of the at least two sets of parameter values is associated with a first communication mode during a first time period of the plurality of communication modes and a second parameter value of the at least two sets of parameter values is associated with a second communication mode during a second time period of the plurality of communication modes. In a twenty-ninth aspect, alone or in combination with one or more of the first through twenty-eighth aspects, the first time period comprises at least one of a first set of symbols or a first set of slots, and wherein the second time period comprises at least one of a second set of symbols or a second set of slots.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 804) performs operations associated with parameter sets for UE communication modes.

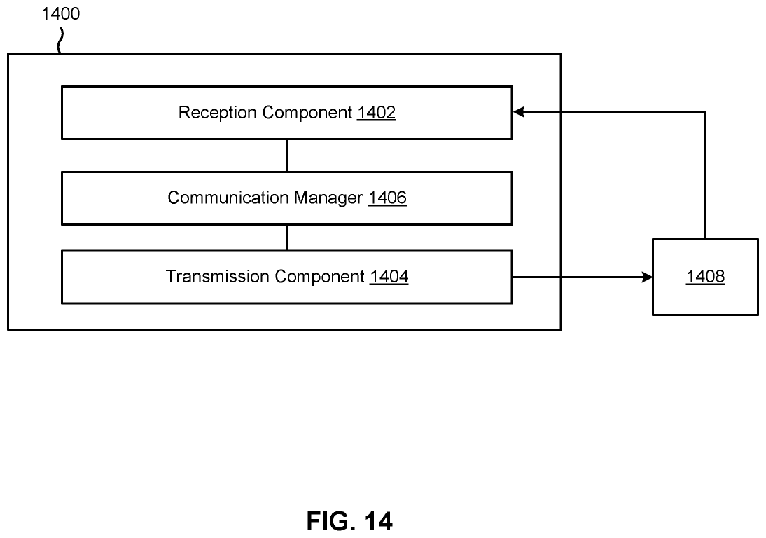

As shown in FIG. 10, in some aspects, process 1000 may include receiving, from a UE, capability information associated with two or more communication modes of a plurality of communication modes, the two or more communication modes comprising at least one FD mode (block 1010). For example, the network node (e.g., using reception component 1402 and/or communication manager 1406, depicted in FIG. 14) may receive, from a UE, capability information associated with two or more communication modes of a plurality of communication modes, the two or more communication modes comprising at least one FD mode, as described above.

As further shown in FIG. 10, in some aspects, process 1000 may include transmitting, to the UE, configuration information associated with the two or more communication modes, the configuration information indicating at least two sets of parameter values, wherein each set of parameter values is associated with a respective communication mode of the two or more communication modes (block 1020). For example, the network node (e.g., using transmission component 1404 and/or communication manager 1406, depicted in FIG. 14) may transmit, to the UE, configuration information associated with the two or more communication modes, the configuration information indicating at least two sets of parameter values, wherein each set of parameter values is associated with a respective communication mode of the two or more communication modes, as described above.

As further shown in FIG. 10, in some aspects, process 1000 may include communicating with the UE based at least in part on the at least two sets of parameter values (block 1030). For example, the network node (e.g., using reception component 1402, transmission component 1404, and/or communication manager 1406, depicted in FIG. 14) may communicate with the UE based at least in part on the at least two sets of parameter values, as described above.

Process 1000 may include additional aspects, such as any single aspect or any combination of aspects described below and/or in connection with one or more other processes described elsewhere herein.

In a first aspect, each set of parameter values of the at least two sets of parameter values indicates at least one of a spatial parameter, an uplink power control parameter, a modulation and coding scheme, an antenna configuration, a timing parameter, or an operation parameter. In a second aspect, alone or in combination with the first aspect, the spatial parameter is indicative of at least one of an antenna configuration, a TCI state, a downlink beam, an uplink beam, or a spatial relation. In a third aspect, alone or in combination with one or more of the first and second aspects, the uplink power control parameter is indicative of at least one of a P0 parameter, an alpha parameter, a closed loop index parameter, or a PL RS parameter. In a fourth aspect, alone or in combination with one or more of the first through third aspects, the timing parameter is indicative of at least one of a transmission timing or a TA.

In a fifth aspect, alone or in combination with one or more of the first through fourth aspects, the operation parameter is indicative of at least one of an RI, a PMI, a TPMI, a DMRS format, a time domain resource allocation, a frequency domain resource allocation, a PUCCH configuration, or a PRG. In a sixth aspect, alone or in combination with one or more of the first through fifth aspects, one or more parameter values of the at least two sets of parameter values is associated with a time period. In a seventh aspect, alone or in combination with one or more of the first through sixth aspects, the time period comprises at least one of a symbol or a slot. In an eighth aspect, alone or in combination with one or more of the first through seventh aspects, one or more parameter values of the at least two sets of parameter values is associated with at least one of a BWP, a downlink subband of an SBFD communication mode, or an uplink subband of the SBFD communication mode.

In a ninth aspect, alone or in combination with one or more of the first through eighth aspects, process 1000 includes transmitting, by the network node and to the UE, a communication mode indication indicative of an operation mode of the two or more communication modes, wherein communicating with the UE comprises communicating in association with the operation mode. In a tenth aspect, alone or in combination with one or more of the first through ninth aspects, the communication mode indication is associated with a mode transition condition. In an eleventh aspect, alone or in combination with one or more of the first through tenth aspects, the mode transition condition is associated with a maximum number of transition points during a specified time period. In a twelfth aspect, alone or in combination with one or more of the first through eleventh aspects, an indication of the maximum number of transition points is maintained in one or more memories of the network node.

In a thirteenth aspect, alone or in combination with one or more of the first through twelfth aspects, the maximum number of transition points is associated with at least one of a transition delay, a UE SBFD capability, a UE partially overlapping FD capability, a UE fully overlapping FD capability, a network node SBFD capability, a network node partially overlapping FD capability, a network node fully overlapping FD capability, an overhead timing for a mode transition, a guard time for the mode transition, a UE implementation complexity, or a network node implementation complexity. In a fourteenth aspect, alone or in combination with one or more of the first through thirteenth aspects, the maximum number of transition points is associated with a TDD uplink/downlink slot format pattern period. In a fifteenth aspect, alone or in combination with one or more of the first through fourteenth aspects, the maximum number of transition points is associated with a semi-static network node SBFD configuration period. In a sixteenth aspect, alone or in combination with one or more of the first through fifteenth aspects, the maximum number of transition points is associated with a slot. In a seventeenth aspect, alone or in combination with one or more of the first through sixteenth aspects, a transition point of the maximum number of transitions points is aligned with a slot boundary. In an eighteenth aspect, alone or in combination with one or more of the first through seventeenth aspects, a transition point of the maximum number of transitions points is aligned within a slot.

In a nineteenth aspect, alone or in combination with one or more of the first through eighteenth aspects, a number of transition points of the maximum number of transition points are associated with a UE transition point capability. In a twentieth aspect, alone or in combination with one or more of the first through nineteenth aspects, the capability information indicates the UE transition point capability. In a twenty-first aspect, alone or in combination with one or more of the first through twentieth aspects, the UE transition point capability is indicative of one or more maximum numbers of transition points. In a twenty-second aspect, alone or in combination with one or more of the first through twenty-first aspects, the one or more maximum numbers of transition points comprises a first maximum number of transition points associated with a first SCS and a second maximum number of transition points associated with a second SCS.

In a twenty-third aspect, alone or in combination with one or more of the first through twenty-second aspects, the UE transition point capability is indicative of only one reference maximum number of transition points for a frequency range. In a twenty-fourth aspect, alone or in combination with one or more of the first through twenty-third aspects, the one reference maximum number of transition points is associated with a first SCS, and wherein a maximum number of transition points associated with a second SCS of the frequency range comprises a scaled value associated with the one reference maximum number of transition points. In a twenty-fifth aspect, alone or in combination with one or more of the first through twenty-fourth aspects, the at least one FD mode comprises at least one of a SBFD mode, a partial overlapping FD mode, or a fully overlapping FD mode.

In a twenty-sixth aspect, alone or in combination with one or more of the first through twenty-fifth aspects, the two or more communication modes comprise at least one of a first mode in which the UE comprises an HD UE and the network node provides an HD cell, wherein, in the first mode, the UE communicates with the network node in association with one communication direction during a time period, a second mode in which the UE comprises a first HD UE of a plurality of HD UEs and the network node provides an SBFD cell, wherein, in the second mode, the UE communicates with the network node in association with one communication direction during the time period, a third mode in which the UE comprises an SBFD UE and the network node provides an SBFD cell, wherein, in the third mode, the UE communicates with the network node in association with two communication directions during the time period, or a fourth mode in which the UE comprises an SBFD UE and the network node provides an HD cell or transmission reception point (TRP) of a plurality of HD cells, wherein, in the fourth mode, the UE communicates via the cell or the TRP in association with a first communication direction during the time period and via an additional cell or an additional TRP in association with a second communication direction during the time period.

In a twenty-seventh aspect, alone or in combination with one or more of the first through twenty-sixth aspects, at least one parameter value of the at least two sets of parameter values is associated with the two or more communication modes of the plurality of communication modes. In a twenty-eighth aspect, alone or in combination with one or more of the first through twenty-seventh aspects, a first parameter value of the at least two sets of parameter values is associated with a first communication mode during a first time period of the plurality of communication modes and a second parameter value of the at least two sets of parameter values is associated with a second communication mode during a second time period of the plurality of communication modes. In a twenty-ninth aspect, alone or in combination with one or more of the first through twenty-eighth aspects, the first time period comprises at least one of a first set of symbols or a first set of slots, and wherein the second time period comprises at least one of a second set of symbols or a second set of slots.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a UE or an apparatus of a UE, in accordance with the present disclosure. Example process 1100 is an example where the apparatus or the UE (e.g., UE 802) performs operations associated with parameter sets for UE communication modes.

As shown in FIG. 11, in some aspects, process 1100 may include receiving, from a network node, configuration information associated with two or more communication modes, of a plurality of communication modes, the two or more communication modes comprising at least one FD mode (block 1110). For example, the UE (e.g., using reception component 1302 and/or communication manager 1306, depicted in FIG. 13) may receive, from a network node, configuration information associated with two or more communication modes, of a plurality of communication modes, the two or more communication modes comprising at least one FD mode, as described above.

As further shown in FIG. 11, in some aspects, process 1100 may include communicating with the network node, in association with a first communication mode of the two or more communication modes (block 1120). For example, the UE (e.g., using reception component 1302, transmission component 1304, and/or communication manager 1306, depicted in FIG. 13) may communicate with the network node, in association with a first communication mode of the two or more communication modes, as described above.

As further shown in FIG. 11, in some aspects, process 1100 may include communicating, associated with a mode transition condition, with the network node in association with a second communication mode of the two or more communication modes, wherein the mode transition condition is associated with a maximum number of transition points during a specified time period (block 1130). For example, the UE (e.g., using reception component 1302, transmission component 1304, and/or communication manager 1306, depicted in FIG. 13) may communicate, associated with a mode transition condition, with the network node in association with a second communication mode of the two or more communication modes, wherein the mode transition condition is associated with a maximum number of transition points during a specified time period, as described above.

Process 1100 may include additional aspects, such as any single aspect or any combination of aspects described below and/or in connection with one or more other processes described elsewhere herein.

In a first aspect, process 1100 includes receiving, by the UE and from the network node, a communication mode indication indicative of an operation mode of the two or more communication modes, wherein communicating with the network node comprises communicating in association with the operation mode. In a second aspect, alone or in combination with the first aspect, the communication mode indication is associated with a mode transition condition. In a third aspect, alone or in combination with one or more of the first and second aspects, an indication of the maximum number of transition points is maintained in one or more memories of the UE.

In a fourth aspect, alone or in combination with one or more of the first through third aspects, the maximum number of transition points is associated with at least one of a transition delay, a UE SBFD capability, a UE partially overlapping FD capability, a UE fully overlapping FD capability, a network node SBFD capability, a network node partially overlapping FD capability, a network node fully overlapping FD capability, an overhead timing for a mode transition, a guard time for the mode transition, a UE implementation complexity, or a network node implementation complexity. In a fifth aspect, alone or in combination with one or more of the first through fourth aspects, the maximum number of transition points is associated with a TDD uplink/downlink slot format pattern period. In a sixth aspect, alone or in combination with one or more of the first through fifth aspects, the maximum number of transition points is associated with a semi-static network node SBFD configuration period. In a seventh aspect, alone or in combination with one or more of the first through sixth aspects, the maximum number of transition points is associated with a slot. In an eighth aspect, alone or in combination with one or more of the first through seventh aspects, a transition point of the maximum number of transitions points is aligned with a slot boundary. In a ninth aspect, alone or in combination with one or more of the first through eighth aspects, a transition point of the maximum number of transitions points is aligned within a slot.

In a tenth aspect, alone or in combination with one or more of the first through ninth aspects, a number of transition points of the maximum number of transition points are associated with a UE transition point capability. In an eleventh aspect, alone or in combination with one or more of the first through tenth aspects, process 1100 includes transmitting, by the UE, capability information that indicates the UE transition point capability. In a twelfth aspect, alone or in combination with one or more of the first through eleventh aspects, the UE transition point capability is indicative of one or more maximum numbers of transition points. In a thirteenth aspect, alone or in combination with one or more of the first through twelfth aspects, the one or more maximum numbers of transition points comprises a first maximum number of transition points associated with a first SCS and a second maximum number of transition points associated with a second SCS. In a fourteenth aspect, alone or in combination with one or more of the first through thirteenth aspects, the UE transition point capability is indicative of only one reference maximum number of transition points for a frequency range. In a fifteenth aspect, alone or in combination with one or more of the first through fourteenth aspects, the one reference maximum number of transition points is associated with a first SCS, and wherein a maximum number of transition points associated with a second SCS of the frequency range comprises a scaled value associated with the one reference maximum number of transition points.

In a sixteenth aspect, alone or in combination with one or more of the first through fifteenth aspects, the at least one FD mode comprises at least one of an SBFD mode, a partial overlapping FD mode, or a fully overlapping FD mode. In a seventeenth aspect, alone or in combination with one or more of the first through sixteenth aspects, the two or more communication modes comprise at least one of a first mode in which the UE comprises an HD UE and the network node provides an HD cell, wherein, in the first mode, the UE communicates with the network node in association with one communication direction during a time period, a second mode in which the UE comprises a first HD UE of a plurality of HD UEs and the network node provides an SBFD cell, wherein, in the second mode, the UE communicates with the network node in association with one communication direction during the time period, a third mode in which the UE comprises an SBFD UE and the network node provides an SBFD cell, wherein, in the third mode, the UE communicates with the network node in association with two communication directions during the time period, or a fourth mode in which the UE comprises an SBFD UE and the network node provides an HD cell or TRP of a plurality of HD cells, wherein, in the fourth mode, the UE communicates via the cell or the TRP in association with a first communication direction during the time period and via an additional cell or an additional TRP in association with a second communication direction during the time period.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node, in accordance with the present disclosure. Example process 1200 is an example where the apparatus or the network node (e.g., network node 804) performs operations associated with parameter sets for UE communication modes.

As shown in FIG. 12, in some aspects, process 1200 may include transmitting, to a UE, configuration information associated with two or more communication modes, of a plurality of communication modes, the two or more communication modes comprising at least one FD mode (block 1210). For example, the network node (e.g., using transmission component 1404 and/or communication manager 1406, depicted in FIG. 14) may transmit, to a UE, configuration information associated with two or more communication modes, of a plurality of communication modes, the two or more communication modes comprising at least one FD mode, as described above.

As further shown in FIG. 12, in some aspects, process 1200 may include communicating with the UE in association with a first communication mode of the two or more communication modes (block 1220). For example, the network node (e.g., using reception component 1402, transmission component 1404, and/or communication manager 1406, depicted in FIG. 14) may communicate with the UE in association with a first communication mode of the two or more communication modes, as described above.

As further shown in FIG. 12, in some aspects, process 1200 may include communicating, associated with a mode transition condition, with the UE in association with a second communication mode of the two or more communication modes, wherein the mode transition condition is associated with a maximum number of transition points during a specified time period (block 1230). For example, the network node (e.g., using reception component 1402, transmission component 1404, and/or communication manager 1406, depicted in FIG. 14) may communicate, associated with a mode transition condition, with the UE in association with a second communication mode of the two or more communication modes, wherein the mode transition condition is associated with a maximum number of transition points during a specified time period, as described above.

Process 1200 may include additional aspects, such as any single aspect or any combination of aspects described below and/or in connection with one or more other processes described elsewhere herein.

In a first aspect, process 1200 includes transmitting, by the network node and to the UE, a communication mode indication indicative of an operation mode of the two or more communication modes, wherein communicating with the UE comprises communicating in association with the operation mode. In a second aspect, alone or in combination with the first aspect, the communication mode indication is associated with a mode transition condition. In a third aspect, alone or in combination with one or more of the first and second aspects, an indication of the maximum number of transition points is maintained in one or more memories of the network node.

In a fourth aspect, alone or in combination with one or more of the first through third aspects, the maximum number of transition points is associated with at least one of a transition delay, a UE SBFD capability, a UE partially overlapping FD capability, a UE fully overlapping FD capability, a network node SBFD capability, a network node partially overlapping FD capability, a network node fully overlapping FD capability, an overhead timing for a mode transition, a guard time for the mode transition, a UE implementation complexity, or a network node implementation complexity. In a fifth aspect, alone or in combination with one or more of the first through fourth aspects, the maximum number of transition points is associated with a DD uplink/downlink slot format pattern period. In a sixth aspect, alone or in combination with one or more of the first through fifth aspects, the maximum number of transition points is associated with a semi-static network node SBFD configuration period. In a seventh aspect, alone or in combination with one or more of the first through sixth aspects, the maximum number of transition points is associated with a slot. In an eighth aspect, alone or in combination with one or more of the first through seventh aspects, a transition point of the maximum number of transitions points is aligned with a slot boundary. In a ninth aspect, alone or in combination with one or more of the first through eighth aspects, a transition point of the maximum number of transitions points is aligned within a slot.

In a tenth aspect, alone or in combination with one or more of the first through ninth aspects, a number of transition points of the maximum number of transition points are associated with a UE transition point capability. In an eleventh aspect, alone or in combination with one or more of the first through tenth aspects, process 1200 includes receiving, by the network node and from the UE, capability information that indicates the UE transition point capability. In a twelfth aspect, alone or in combination with one or more of the first through eleventh aspects, the UE transition point capability is indicative of one or more maximum numbers of transition points. In a thirteenth aspect, alone or in combination with one or more of the first through twelfth aspects, the one or more maximum numbers of transition points comprises a first maximum number of transition points associated with a first SCS and a second maximum number of transition points associated with a second SCS. In a fourteenth aspect, alone or in combination with one or more of the first through thirteenth aspects, the UE transition point capability is indicative of only one reference maximum number of transition points for a frequency range.

In a fifteenth aspect, alone or in combination with one or more of the first through fourteenth aspects, the one reference maximum number of transition points is associated with a first SCS, and wherein a maximum number of transition points associated with a second SCS of the frequency range comprises a scaled value associated with the one reference maximum number of transition points. In a sixteenth aspect, alone or in combination with one or more of the first through fifteenth aspects, the at least one FD mode comprises at least one of a SBFD mode, a partial overlapping FD mode, or a fully overlapping FD mode. In a seventeenth aspect, alone or in combination with one or more of the first through sixteenth aspects, the two or more communication modes comprise at least one of a first mode in which the UE comprises an HD UE and the network node provides an HD cell, wherein, in the first mode, the UE communicates with the network node in association with one communication direction during a time period, a second mode in which the UE comprises a first HD UE of a plurality of HD UEs and the network node provides an SBFD cell, wherein, in the second mode, the UE communicates with the network node in association with one communication direction during the time period, a third mode in which the UE comprises an SBFD UE and the network node provides an SBFD cell, wherein, in the third mode, the UE communicates with the network node in association with two communication directions during the time period, or a fourth mode in which the UE comprises an SBFD UE and the network node provides an HD cell or transmission reception point (TRP) of a plurality of HD cells, wherein, in the fourth mode, the UE communicates via the cell or the TRP in association with a first communication direction during the time period and via an additional cell or an additional TRP in association with a second communication direction during the time period.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIG. 8. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The transmission component 1304 may transmit, to a network node, capability information associated with two or more communication modes of a plurality of communication modes, the two or more communication modes comprising at least one FD mode. The reception component 1302 may receive, from the network node, configuration information associated with the two or more communication modes, the configuration information indicating at least two sets of parameter values, where each set of parameter values is associated with a respective communication mode of the two or more communication modes. The reception component 1302 and/or the transmission component 1304 may communicate with the network node based at least in part on the at least two sets of parameter values. The reception component 1302 may receive, from the network node, a communication mode indication indicative of an operation mode of the two or more communication modes, wherein communicating with the network node comprises communicating in association with the operation mode.

The reception component 1302 may receive, from a network node, configuration information associated with two or more communication modes, of a plurality of communication modes, the two or more communication modes comprising at least one FD mode. The reception component 1302 and/or the transmission component 1304 may communicate with the network node, in association with a first communication mode of the two or more communication modes. The reception component 1302 and/or the transmission component 1304 may communicate, associated with a mode transition condition, with the network node in association with a second communication mode of the two or more communication modes, wherein the mode transition condition is associated with a maximum number of transition points during a specified time period. The reception component 1302 may receive, from the network node, a communication mode indication indicative of an operation mode of the two or more communication modes, wherein communicating with the network node comprises communicating in association with the operation mode. The transmission component 1304 may transmit capability information that indicates the UE transition point capability.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIG. 8. Additionally, or alternatively, the apparatus 1400 may be configured to perform one or more processes described herein, such as process 1000 of FIG. 10, process 1200 of FIG. 12, or a combination thereof. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive, from a UE, capability information associated with two or more communication modes of a plurality of communication modes, the two or more communication modes comprising at least one FD mode. The transmission component 1404 may transmit, to the UE, configuration information associated with the two or more communication modes, the configuration information indicating at least two sets of parameter values, wherein each set of parameter values is associated with a respective communication mode of the two or more communication modes. The reception component 1402 and/or the transmission component 1404 may communicate with the UE based at least in part on the at least two sets of parameter values. The transmission component 1404 may transmit, to the UE, a communication mode indication indicative of an operation mode of the two or more communication modes, wherein communicating with the UE comprises communicating in association with the operation mode.

The transmission component 1404 may transmit, to a UE, configuration information associated with two or more communication modes, of a plurality of communication modes, the two or more communication modes comprising at least one FD mode. The reception component 1402 and/or the transmission component 1404 may communicate with the UE in association with a first communication mode of the two or more communication modes. The reception component 1402 and/or the transmission component 1404 may communicate, associated with a mode transition condition, with the UE in association with a second communication mode of the two or more communication modes, wherein the mode transition condition is associated with a maximum number of transition points during a specified time period. The transmission component 1404 may transmit, to the UE, a communication mode indication indicative of an operation mode of the two or more communication modes, wherein communicating with the UE comprises communicating in association with the operation mode. The reception component 1402 may receive, from the UE, capability information that indicates the UE transition point capability.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by an apparatus at a user equipment (UE), comprising: transmitting, by the UE and to a network node, capability information associated with two or more communication modes of a plurality of communication modes, the two or more communication modes comprising at least one full duplex (FD) mode; receiving, by the UE and from the network node, configuration information associated with the two or more communication modes, the configuration information indicating at least two sets of parameter values, wherein each set of parameter values is associated with a respective communication mode of the two or more communication modes; and communicating, by the UE, with the network node based at least in part on the at least two sets of parameter values.

Aspect 2: The method of Aspect 1, wherein each set of parameter values of the at least two sets of parameter values indicates at least one of a spatial parameter, an uplink power control parameter, a modulation and coding scheme, an antenna configuration, a timing parameter, or an operation parameter.

Aspect 3: The method of Aspect 2, wherein the spatial parameter is indicative of at least one of an antenna configuration, a transmission configuration indicator (TCI) state, a downlink beam, an uplink beam, or a spatial relation.

Aspect 4: The method of either of Aspects 2 or 3, wherein the uplink power control parameter is indicative of at least one of a P0 parameter, an alpha parameter, a closed loop index parameter, or a pathloss reference signal (PL RS) parameter.

Aspect 5: The method of any of Aspects 2-4, wherein the timing parameter is indicative of at least one of a transmission timing or a timing advance (TA).

Aspect 6: The method of any of Aspects 2-5, wherein the operation parameter is indicative of at least one of a rank indicator (RI), a precoding matrix indicator (PMI), a transmit precoder matrix indicator (TPMI), a demodulation reference signal (DMRS) format, a time domain resource allocation, a frequency domain resource allocation, a physical uplink control channel (PUCCH) configuration, or a precoding resource block group (PRG).

Aspect 7: The method of any of Aspects 1-6, wherein one or more parameter values of the at least two sets of parameter values is associated with a time period.

Aspect 8: The method of Aspect 7, wherein the time period comprises at least one of a symbol or a slot.

Aspect 9: The method of any of Aspects 1-8, wherein one or more parameter values of the at least two sets of parameter values is associated with at least one of a bandwidth part (BWP), a downlink subband of an SBFD communication mode, or an uplink subband of the SBFD communication mode.

Aspect 10: The method of any of Aspects 1-9, further comprising receiving, by the UE and from the network node, a communication mode indication indicative of an operation mode of the two or more communication modes, wherein communicating with the network node comprises communicating in association with the operation mode.

Aspect 11: The method of Aspect 10, wherein the communication mode indication is associated with a mode transition condition.

Aspect 12: The method of Aspect 11, wherein the mode transition condition is associated with a maximum number of transition points during a specified time period.

Aspect 13: The method of Aspect 12, wherein an indication of the maximum number of transition points is maintained in one or more memories of the UE.

Aspect 14: The method of either of Aspects 12 or 13, wherein the maximum number of transition points is associated with at least one of a transition delay, a UE subband FD (SBFD) capability, a UE partially overlapping FD capability, a UE fully overlapping FD capability, a network node SBFD capability, a network node partially overlapping FD capability, a network node fully overlapping FD capability, an overhead timing for a mode transition, a guard time for the mode transition, a UE implementation complexity, or a network node implementation complexity.

Aspect 15: The method of any of Aspects 12-14, wherein the maximum number of transition points is associated with a time division duplexing (TDD) uplink/downlink slot format pattern period.

Aspect 16: The method of any of Aspects 12-15, wherein the maximum number of transition points is associated with a semi-static network node subband FD (SBFD) configuration period.

Aspect 17: The method of any of Aspects 12-16, wherein the maximum number of transition points is associated with a slot.

Aspect 18: The method of any of Aspects 12-17, wherein a transition point of the maximum number of transitions points is aligned with a slot boundary.

Aspect 19: The method of any of Aspects 12-18, wherein a transition point of the maximum number of transitions points is aligned within a slot.

Aspect 20: The method of any of Aspects 12-19, wherein a number of transition points of the maximum number of transition points are associated with a UE transition point capability.

Aspect 21: The method of Aspect 20, wherein the capability information indicates the UE transition point capability.

Aspect 22: The method of either of claim 20 or 21, wherein the UE transition point capability is indicative of one or more maximum numbers of transition points.

Aspect 23: The method of Aspect 22, wherein the one or more maximum numbers of transition points comprises a first maximum number of transition points associated with a first subcarrier spacing (SCS) and a second maximum number of transition points associated with a second SCS.

Aspect 24: The method of any of Aspects 20-23, wherein the UE transition point capability is indicative of only one reference maximum number of transition points for a frequency range.

Aspect 25: The method of Aspect 24, wherein the one reference maximum number of transition points is associated with a first subcarrier spacing (SCS), and wherein a maximum number of transition points associated with a second SCS of the frequency range comprises a scaled value associated with the one reference maximum number of transition points.

Aspect 26: The method of any of Aspects 1-25, wherein the at least one FD mode comprises at least one of a subband FD (SBFD) mode, a partial overlapping FD mode, or a fully overlapping FD mode.

Aspect 27: The method of any of Aspects 1-26, wherein the two or more communication modes comprise at least one of: a first mode in which the UE comprises an HD UE and the network node provides an HD cell, wherein, in the first mode, the UE communicates with the network node in association with one communication direction during a time period; a second mode in which the UE comprises a first HD UE of a plurality of HD UEs and the network node provides an SBFD cell, wherein, in the second mode, the UE communicates with the network node in association with one communication direction during the time period; a third mode in which the UE comprises an SBFD UE and the network node provides an SBFD cell, wherein, in the third mode, the UE communicates with the network node in association with two communication directions during the time period; or a fourth mode in which the UE comprises an SBFD UE and the network node provides an HD cell or transmission reception point (TRP) of a plurality of HD cells, wherein, in the fourth mode, the UE communicates via the cell or the TRP in association with a first communication direction during the time period and via an additional cell or an additional TRP in association with a second communication direction during the time period.

Aspect 28: The method of any of Aspects 1-27, wherein at least one parameter value of the at least two sets of parameter values is associated with the two or more communication modes of the plurality of communication modes.

Aspect 29: The method of any of Aspects 1-28, wherein a first parameter value of the at least two sets of parameter values is associated with a first communication mode during a first time period of the plurality of communication modes and a second parameter value of the at least two sets of parameter values is associated with a second communication mode during a second time period of the plurality of communication modes.

Aspect 30: The method of Aspect 29, wherein the first time period comprises at least one of a first set of symbols or a first set of slots, and wherein the second time period comprises at least one of a second set of symbols or a second set of slots.

Aspect 31: A method of wireless communication performed by an apparatus at a network node, comprising: receiving, by the network node and from a user equipment (UE), capability information associated with two or more communication modes of a plurality of communication modes, the two or more communication modes comprising at least one full duplex (FD) mode; transmitting, by the network node and to the UE, configuration information associated with the two or more communication modes, the configuration information indicating at least two sets of parameter values, wherein each set of parameter values is associated with a respective communication mode of the two or more communication modes; and communicating, by the network node, with the UE based at least in part on the at least two sets of parameter values.

Aspect 32: The method of Aspect 31, wherein each set of parameter values of the at least two sets of parameter values indicates at least one of a spatial parameter, an uplink power control parameter, a modulation and coding scheme, an antenna configuration, a timing parameter, or an operation parameter.

Aspect 33: The method of Aspect 32, wherein the spatial parameter is indicative of at least one of an antenna configuration, a transmission configuration indicator (TCI) state, a downlink beam, an uplink beam, or a spatial relation.

Aspect 34: The method of either of Aspects 32 or 33, wherein the uplink power control parameter is indicative of at least one of a P0 parameter, an alpha parameter, a closed loop index parameter, or a pathloss reference signal (PL RS) parameter.

Aspect 35: The method of any of Aspects 32-34, wherein the timing parameter is indicative of at least one of a transmission timing or a timing advance (TA).

Aspect 36: The method of any of Aspects 32-35, wherein the operation parameter is indicative of at least one of a rank indicator (RI), a precoding matrix indicator (PMI), a transmit precoder matrix indicator (TPMI), a demodulation reference signal (DMRS) format, a time domain resource allocation, a frequency domain resource allocation, a physical uplink control channel (PUCCH) configuration, or a precoding resource block group (PRG).

Aspect 37: The method of any of Aspects 31-36, wherein one or more parameter values of the at least two sets of parameter values is associated with a time period.

Aspect 38: The method of Aspect 37, wherein the time period comprises at least one of a symbol or a slot.

Aspect 39: The method of any of Aspects 31-38, wherein one or more parameter values of the at least two sets of parameter values is associated with at least one of a bandwidth part (BWP), a downlink subband of an SBFD communication mode, or an uplink subband of the SBFD communication mode.

Aspect 40: The method of any of Aspects 31-39, further comprising transmitting, by the network node and to the UE, a communication mode indication indicative of an operation mode of the two or more communication modes, wherein communicating with the UE comprises communicating in association with the operation mode.

Aspect 41: The method of Aspect 40, wherein the communication mode indication is associated with a mode transition condition.

Aspect 42: The method of Aspect 41, wherein the mode transition condition is associated with a maximum number of transition points during a specified time period.

Aspect 43: The method of Aspect 42, wherein an indication of the maximum number of transition points is maintained in one or more memories of the network node.

Aspect 44: The method of either of Aspects 42 or 43, wherein the maximum number of transition points is associated with at least one of a transition delay, a UE subband FD (SBFD) capability, a UE partially overlapping FD capability, a UE fully overlapping FD capability, a network node SBFD capability, a network node partially overlapping FD capability, a network node fully overlapping FD capability, an overhead timing for a mode transition, a guard time for the mode transition, a UE implementation complexity, or a network node implementation complexity.

Aspect 45: The method of any of Aspects 42-44, wherein the maximum number of transition points is associated with a time division duplexing (TDD) uplink/downlink slot format pattern period.

Aspect 46: The method of any of Aspects 42-45, wherein the maximum number of transition points is associated with a semi-static network node subband FD (SBFD) configuration period.

Aspect 47: The method of any of Aspects 42-46, wherein the maximum number of transition points is associated with a slot.

Aspect 48: The method of any of Aspects 42-47, wherein a transition point of the maximum number of transitions points is aligned with a slot boundary.

Aspect 49: The method of any of Aspects 42-48, wherein a transition point of the maximum number of transitions points is aligned within a slot.

Aspect 50: The method of any of Aspects 42-49, wherein a number of transition points of the maximum number of transition points are associated with a UE transition point capability.

Aspect 51: The method of Aspect 50, wherein the capability information indicates the UE transition point capability.

Aspect 52: The method of either of claim 50 or 51, wherein the UE transition point capability is indicative of one or more maximum numbers of transition points.

Aspect 53: The method of Aspect 52, wherein the one or more maximum numbers of transition points comprises a first maximum number of transition points associated with a first subcarrier spacing (SCS) and a second maximum number of transition points associated with a second SCS.

Aspect 54: The method of any of Aspects 50-53, wherein the UE transition point capability is indicative of only one reference maximum number of transition points for a frequency range.

Aspect 55: The method of Aspect 54, wherein the one reference maximum number of transition points is associated with a first subcarrier spacing (SCS), and wherein a maximum number of transition points associated with a second SCS of the frequency range comprises a scaled value associated with the one reference maximum number of transition points.

Aspect 56: The method of any of Aspects 31-55, wherein the at least one FD mode comprises at least one of a subband FD (SBFD) mode, a partial overlapping FD mode, or a fully overlapping FD mode.

Aspect 57: The method of any of Aspects 31-56, wherein the two or more communication modes comprise at least one of: a first mode in which the UE comprises an HD UE and the network node provides an HD cell, wherein, in the first mode, the UE communicates with the network node in association with one communication direction during a time period; a second mode in which the UE comprises a first HD UE of a plurality of HD UEs and the network node provides an SBFD cell, wherein, in the second mode, the UE communicates with the network node in association with one communication direction during the time period; a third mode in which the UE comprises an SBFD UE and the network node provides an SBFD cell, wherein, in the third mode, the UE communicates with the network node in association with two communication directions during the time period; or a fourth mode in which the UE comprises an SBFD UE and the network node provides an HD cell or transmission reception point (TRP) of a plurality of HD cells, wherein, in the fourth mode, the UE communicates via the cell or the TRP in association with a first communication direction during the time period and via an additional cell or an additional TRP in association with a second communication direction during the time period.

Aspect 58: The method of any of Aspects 31-57, wherein at least one parameter value of the at least two sets of parameter values is associated with the two or more communication modes of the plurality of communication modes.

Aspect 59: The method of any of Aspects 31-58, wherein a first parameter value of the at least two sets of parameter values is associated with a first communication mode during a first time period of the plurality of communication modes and a second parameter value of the at least two sets of parameter values is associated with a second communication mode during a second time period of the plurality of communication modes.

Aspect 60: The method of Aspect 59, wherein the first time period comprises at least one of a first set of symbols or a first set of slots, and wherein the second time period comprises at least one of a second set of symbols or a second set of slots.

Aspect 61: A method of wireless communication performed by an apparatus at a user equipment (UE), comprising: receiving, by the UE and from a network node, configuration information associated with two or more communication modes, of a plurality of communication modes, the two or more communication modes comprising at least one full duplex (FD) mode; communicating, by the UE, with the network node, in association with a first communication mode of the two or more communication modes; and communicating, by the UE and associated with a mode transition condition, with the network node in association with a second communication mode of the two or more communication modes, wherein the mode transition condition is associated with a maximum number of transition points during a specified time period.

Aspect 62: The method of Aspect 61, further comprising receiving, by the UE and from the network node, a communication mode indication indicative of an operation mode of the two or more communication modes, wherein communicating with the network node comprises communicating in association with the operation mode.

Aspect 63: The method of Aspect 62, wherein the communication mode indication is associated with a mode transition condition.

Aspect 64: The method of any of Aspects 61-63, wherein an indication of the maximum number of transition points is maintained in one or more memories of the UE.

Aspect 65: The method of any of Aspects 61-64, wherein the maximum number of transition points is associated with at least one of a transition delay, a UE subband FD (SBFD) capability, a UE partially overlapping FD capability, a UE fully overlapping FD capability, a network node SBFD capability, a network node partially overlapping FD capability, a network node fully overlapping FD capability, an overhead timing for a mode transition, a guard time for the mode transition, a UE implementation complexity, or a network node implementation complexity.

Aspect 66: The method of any of Aspects 61-65, wherein the maximum number of transition points is associated with a time division duplexing (TDD) uplink/downlink slot format pattern period.

Aspect 67: The method of any of Aspects 61-66, wherein the maximum number of transition points is associated with a semi-static network node subband FD (SBFD) configuration period.

Aspect 68: The method of any of Aspects 61-67, wherein the maximum number of transition points is associated with a slot.

Aspect 69: The method of any of Aspects 61-68, wherein a transition point of the maximum number of transitions points is aligned with a slot boundary.

Aspect 70: The method of any of Aspects 61-69, wherein a transition point of the maximum number of transitions points is aligned within a slot.

Aspect 71: The method of any of Aspects 61-70, wherein a number of transition points of the maximum number of transition points are associated with a UE transition point capability.

Aspect 72: The method of Aspect 71, further comprising transmitting, by the UE, capability information that indicates the UE transition point capability.

Aspect 73: The method of either of claim 71 or 72, wherein the UE transition point capability is indicative of one or more maximum numbers of transition points.

Aspect 74: The method of Aspect 73, wherein the one or more maximum numbers of transition points comprises a first maximum number of transition points associated with a first subcarrier spacing (SCS) and a second maximum number of transition points associated with a second SCS.

Aspect 75: The method of any of Aspects 71-74, wherein the UE transition point capability is indicative of only one reference maximum number of transition points for a frequency range.

Aspect 76: The method of Aspect 75, wherein the one reference maximum number of transition points is associated with a first subcarrier spacing (SCS), and

wherein a maximum number of transition points associated with a second SCS of the frequency range comprises a scaled value associated with the one reference maximum number of transition points.

Aspect 77: The method of any of Aspects 61-76, wherein the at least one FD mode comprises at least one of a subband FD (SBFD) mode, a partial overlapping FD mode, or a fully overlapping FD mode.

Aspect 78: The method of any of Aspects 61-77, wherein the two or more communication modes comprise at least one of: a first mode in which the UE comprises an HD UE and the network node provides an HD cell, wherein, in the first mode, the UE communicates with the network node in association with one communication direction during a time period; a second mode in which the UE comprises a first HD UE of a plurality of HD UEs and the network node provides an SBFD cell, wherein, in the second mode, the UE communicates with the network node in association with one communication direction during the time period; a third mode in which the UE comprises an SBFD UE and the network node provides an SBFD cell, wherein, in the third mode, the UE communicates with the network node in association with two communication directions during the time period; or a fourth mode in which the UE comprises an SBFD UE and the network node provides an HD cell or transmission reception point (TRP) of a plurality of HD cells, wherein, in the fourth mode, the UE communicates via the cell or the TRP in association with a first communication direction during the time period and via an additional cell or an additional TRP in association with a second communication direction during the time period.

Aspect 79: A method of wireless communication performed by an apparatus at a network node, comprising: transmitting, by the network node and to a user equipment (UE), configuration information associated with two or more communication modes, of a plurality of communication modes, the two or more communication modes comprising at least one full duplex (FD) mode; communicating, by the network node, with the UE in association with a first communication mode of the two or more communication modes; and communicating, by the network node and associated with a mode transition condition, with the UE in association with a second communication mode of the two or more communication modes, wherein the mode transition condition is associated with a maximum number of transition points during a specified time period.

Aspect 80: The method of Aspect 79, further comprising transmitting, by the network node and to the UE, a communication mode indication indicative of an operation mode of the two or more communication modes, wherein communicating with the UE comprises communicating in association with the operation mode.

Aspect 81: The method of Aspect 80, wherein the communication mode indication is associated with a mode transition condition.

Aspect 82: The method of any of Aspects 79-81, wherein an indication of the maximum number of transition points is maintained in one or more memories of the network node.

Aspect 83: The method of any of Aspects 79-82, wherein the maximum number of transition points is associated with at least one of a transition delay, a UE subband FD (SBFD) capability, a UE partially overlapping FD capability, a UE fully overlapping FD capability, a network node SBFD capability, a network node partially overlapping FD capability, a network node fully overlapping FD capability, an overhead timing for a mode transition, a guard time for the mode transition, a UE implementation complexity, or a network node implementation complexity.

Aspect 84: The method of any of Aspects 79-83, wherein the maximum number of transition points is associated with a time division duplexing (TDD) uplink/downlink slot format pattern period.

Aspect 85: The method of any of Aspects 79-84, wherein the maximum number of transition points is associated with a semi-static network node subband FD (SBFD) configuration period.

Aspect 86: The method of any of Aspects 79-85, wherein the maximum number of transition points is associated with a slot.

Aspect 87: The method of any of Aspects 79-86, wherein a transition point of the maximum number of transitions points is aligned with a slot boundary.

Aspect 88: The method of any of Aspects 79-87, wherein a transition point of the maximum number of transitions points is aligned within a slot.

Aspect 89: The method of any of Aspects 79-88, wherein a number of transition points of the maximum number of transition points are associated with a UE transition point capability.

Aspect 90: The method of Aspect 89, further comprising receiving, by the network node and from the UE, capability information that indicates the UE transition point capability.

Aspect 91: The method of either of claim 89 or 90, wherein the UE transition point capability is indicative of one or more maximum numbers of transition points.

Aspect 92: The method of Aspect 91, wherein the one or more maximum numbers of transition points comprises a first maximum number of transition points associated with a first subcarrier spacing (SCS) and a second maximum number of transition points associated with a second SCS.

Aspect 93: The method of any of Aspects 89-92, wherein the UE transition point capability is indicative of only one reference maximum number of transition points for a frequency range.

Aspect 94: The method of Aspect 93, wherein the one reference maximum number of transition points is associated with a first subcarrier spacing (SCS), and wherein a maximum number of transition points associated with a second SCS of the frequency range comprises a scaled value associated with the one reference maximum number of transition points.

Aspect 95: The method of any of Aspects 79-94, wherein the at least one FD mode comprises at least one of a subband FD (SBFD) mode, a partial overlapping FD mode, or a fully overlapping FD mode.

Aspect 96: The method of any of Aspects 79-95, wherein the two or more communication modes comprise at least one of: a first mode in which the UE comprises an HD UE and the network node provides an HD cell, wherein, in the first mode, the UE communicates with the network node in association with one communication direction during a time period; a second mode in which the UE comprises a first HD UE of a plurality of HD UEs and the network node provides an SBFD cell, wherein, in the second mode, the UE communicates with the network node in association with one communication direction during the time period; a third mode in which the UE comprises an SBFD UE and the network node provides an SBFD cell, wherein, in the third mode, the UE communicates with the network node in association with two communication directions during the time period; or a fourth mode in which the UE comprises an SBFD UE and the network node provides an HD cell or transmission reception point (TRP) of a plurality of HD cells, wherein, in the fourth mode, the UE communicates via the cell or the TRP in association with a first communication direction during the time period and via an additional cell or an additional TRP in association with a second communication direction during the time period.

Aspect 97: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 98: An apparatus for wireless communication at a device, the apparatus comprising one or more memories and one or more processors coupled to the one or more memories, the one or more processors configured to cause the device to perform the method of one or more of Aspects 1-30.

Aspect 99: An apparatus for wireless communication, the apparatus comprising at least one means for performing the method of one or more of Aspects 1-30.

Aspect 100: A non-transitory computer-readable medium storing code for wireless communication, the code comprising instructions executable by one or more processors to perform the method of one or more of Aspects 1-30.

Aspect 101: A non-transitory computer-readable medium storing a set of instructions for wireless communication, the set of instructions comprising one or more instructions that, when executed by one or more processors of a device, cause the device to perform the method of one or more of Aspects 1-30.

Aspect 102: A device for wireless communication, the device comprising a processing system that includes one or more processors and one or more memories coupled with the one or more processors, the processing system configured to cause the device to perform the method of one or more of Aspects 1-30.

Aspect 103: An apparatus for wireless communication at a device, the apparatus comprising one or more memories and one or more processors coupled to the one or more memories, the one or more processors individually or collectively configured to cause the device to perform the method of one or more of Aspects 1-30.

Aspect 104: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 31-60.

Aspect 105: An apparatus for wireless communication at a device, the apparatus comprising one or more memories and one or more processors coupled to the one or more memories, the one or more processors configured to cause the device to perform the method of one or more of Aspects 31-60.

Aspect 106: An apparatus for wireless communication, the apparatus comprising at least one means for performing the method of one or more of Aspects 31-60.

Aspect 107: A non-transitory computer-readable medium storing code for wireless communication, the code comprising instructions executable by one or more processors to perform the method of one or more of Aspects 31-60.

Aspect 108: A non-transitory computer-readable medium storing a set of instructions for wireless communication, the set of instructions comprising one or more instructions that, when executed by one or more processors of a device, cause the device to perform the method of one or more of Aspects 31-60.

Aspect 109: A device for wireless communication, the device comprising a processing system that includes one or more processors and one or more memories coupled with the one or more processors, the processing system configured to cause the device to perform the method of one or more of Aspects 31-60.

Aspect 110: An apparatus for wireless communication at a device, the apparatus comprising one or more memories and one or more processors coupled to the one or more memories, the one or more processors individually or collectively configured to cause the device to perform the method of one or more of Aspects 31-60.

Aspect 111: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 61-78.

Aspect 112: An apparatus for wireless communication at a device, the apparatus comprising one or more memories and one or more processors coupled to the one or more memories, the one or more processors configured to cause the device to perform the method of one or more of Aspects 61-78.

Aspect 113: An apparatus for wireless communication, the apparatus comprising at least one means for performing the method of one or more of Aspects 61-78.

Aspect 114: A non-transitory computer-readable medium storing code for wireless communication, the code comprising instructions executable by one or more processors to perform the method of one or more of Aspects 61-78.

Aspect 115: A non-transitory computer-readable medium storing a set of instructions for wireless communication, the set of instructions comprising one or more instructions that, when executed by one or more processors of a device, cause the device to perform the method of one or more of Aspects 61-78.

Aspect 116: A device for wireless communication, the device comprising a processing system that includes one or more processors and one or more memories coupled with the one or more processors, the processing system configured to cause the device to perform the method of one or more of Aspects 61-78.

Aspect 117: An apparatus for wireless communication at a device, the apparatus comprising one or more memories and one or more processors coupled to the one or more memories, the one or more processors individually or collectively configured to cause the device to perform the method of one or more of Aspects 61-78.

Aspect 118: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 79-96.

Aspect 119: An apparatus for wireless communication at a device, the apparatus comprising one or more memories and one or more processors coupled to the one or more memories, the one or more processors configured to cause the device to perform the method of one or more of Aspects 79-96.

Aspect 120: An apparatus for wireless communication, the apparatus comprising at least one means for performing the method of one or more of Aspects 79-96.

Aspect 121: A non-transitory computer-readable medium storing code for wireless communication, the code comprising instructions executable by one or more processors to perform the method of one or more of Aspects 79-96.

Aspect 122: A non-transitory computer-readable medium storing a set of instructions for wireless communication, the set of instructions comprising one or more instructions that, when executed by one or more processors of a device, cause the device to perform the method of one or more of Aspects 79-96.

Aspect 123: A device for wireless communication, the device comprising a processing system that includes one or more processors and one or more memories coupled with the one or more processors, the processing system configured to cause the device to perform the method of one or more of Aspects 79-96.

Aspect 124: An apparatus for wireless communication at a device, the apparatus comprising one or more memories and one or more processors coupled to the one or more memories, the one or more processors individually or collectively configured to cause the device to perform the method of one or more of Aspects 79-96.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, the one or more processors, individually or collectively and based at least in part on information stored in the one or more memories, being configured to:
transmit, to a network node, capability information associated with two or more communication modes of a plurality of communication modes, the two or more communication modes comprising at least one FD mode;
receive, from the network node, configuration information associated with the two or more communication modes, the configuration information indicating at least two sets of parameter values, wherein each set of parameter values is associated with a respective communication mode of the two or more communication modes; and
communicate with the network node based at least in part on the at least two sets of parameter values.

2. The apparatus of claim 1, wherein each set of parameter values of the at least two sets of parameter values indicates at least one of a spatial parameter, an uplink power control parameter, a modulation and coding scheme, an antenna configuration, a timing parameter, or an operation parameter.

3. The apparatus of claim 2, wherein the spatial parameter is indicative of at least one of an antenna configuration, a transmission configuration indicator (TCI) state, a downlink beam, an uplink beam, or a spatial relation.

4. The apparatus of claim 2, wherein the uplink power control parameter is indicative of at least one of a P0 parameter, an alpha parameter, a closed loop index parameter, or a pathloss reference signal (PL RS) parameter.

5. The apparatus of claim 2, wherein the timing parameter is indicative of at least one of a transmission timing or a timing advance (TA).

6. The apparatus of claim 2, wherein the operation parameter is indicative of at least one of a rank indicator (RI), a precoding matrix indicator (PMI), a transmit precoder matrix indicator (TPMI), a demodulation reference signal (DMRS) format, a time domain resource allocation, a frequency domain resource allocation, a physical uplink control channel (PUCCH) configuration, or a precoding resource block group (PRG).

7. The apparatus of claim 1, wherein one or more parameter values of the at least two sets of parameter values is associated with a time period.

8. The apparatus of claim 7, wherein the time period comprises at least one of a symbol or a slot.

9. The apparatus of claim 1, wherein one or more parameter values of the at least two sets of parameter values is associated with at least one of a bandwidth part (BWP), a downlink subband of an SBFD communication mode, or an uplink subband of the SBFD communication mode.

10. The apparatus of claim 1, wherein the one or more processors are further configured to receive, from the network node, a communication mode indication indicative of an operation mode of the two or more communication modes, wherein communicating with the network node comprises communicating in association with the operation mode.

11. The apparatus of claim 10, wherein the communication mode indication is associated with a mode transition condition.

12. The apparatus of claim 11, wherein the mode transition condition is associated with a maximum number of transition points during a specified time period.

13. The apparatus of claim 12, wherein an indication of the maximum number of transition points is maintained in one or more memories of the UE.

14. The apparatus of claim 12, wherein the maximum number of transition points is associated with at least one of a transition delay, a UE subband FD (SBFD) capability, a UE partially overlapping FD capability, a UE fully overlapping FD capability, a network node SBFD capability, a network node partially overlapping FD capability, a network node fully overlapping FD capability, an overhead timing for a mode transition, a guard time for the mode transition, a UE implementation complexity, or a network node implementation complexity.

15. The apparatus of claim 12, wherein the maximum number of transition points is associated with at least one of a time division duplexing (TDD) uplink/downlink slot format pattern period, a semi-static network node subband FD (SBFD) configuration period, or a slot.

16. The apparatus of claim 12, wherein a number of transition points of the maximum number of transition points are associated with a UE transition point capability.

17. The apparatus of claim 16, wherein the UE transition point capability is indicative of one or more maximum numbers of transition points.

18. The apparatus of claim 17, wherein the one or more maximum numbers of transition points comprises a first maximum number of transition points associated with a first subcarrier spacing (SCS) and a second maximum number of transition points associated with a second SCS.

19. The apparatus of claim 16, wherein the UE transition point capability is indicative of only one reference maximum number of transition points for a frequency range, wherein the one reference maximum number of transition points is associated with a first subcarrier spacing (SCS), and wherein a maximum number of transition points associated with a second SCS of the frequency range comprises a scaled value associated with the one reference maximum number of transition points.

20. The apparatus of claim 1, wherein the at least one FD mode comprises at least one of a subband FD (SBFD) mode, a partial overlapping FD mode, or a fully overlapping FD mode.

21. The apparatus of claim 1, wherein the two or more communication modes comprise at least one of:
a first mode in which the UE comprises an HD UE and the network node provides an HD cell, wherein, in the first mode, the UE communicates with the network node in association with one communication direction during a time period;
a second mode in which the UE comprises a first HD UE of a plurality of HD UEs and the network node provides an SBFD cell, wherein, in the second mode, the UE communicates with the network node in association with one communication direction during the time period;
a third mode in which the UE comprises an SBFD UE and the network node provides an SBFD cell, wherein, in the third mode, the UE communicates with the network node in association with two communication directions during the time period; or
a fourth mode in which the UE comprises an SBFD UE and the network node provides an HD cell or transmission reception point (TRP) of a plurality of HD cells, wherein, in the fourth mode, the UE communicates via the cell or the TRP in association with a first communication direction during the time period and via an additional cell or an additional TRP in association with a second communication direction during the time period.

22. The apparatus of claim 1, wherein at least one parameter value of the at least two sets of parameter values is associated with the two or more communication modes of the plurality of communication modes.

23. The apparatus of claim 1, wherein a first parameter value of the at least two sets of parameter values is associated with a first communication mode during a first time period of the plurality of communication modes and a second parameter value of the at least two sets of parameter values is associated with a second communication mode during a second time period of the plurality of communication modes.

24. The apparatus of claim 23, wherein the first time period comprises at least one of a first set of symbols or a first set of slots, and wherein the second time period comprises at least one of a second set of symbols or a second set of slots.

25. An apparatus for wireless communication at a network node, comprising:
one or more memories; and
one or more processors, the one or more processors, individually or collectively and based at least in part on information stored in the one or more memories, being configured to:
receive, from a user equipment (UE), capability information associated with two or more communication modes of a plurality of communication modes, the two or more communication modes comprising at least one FD mode;
transmit, to the UE, configuration information associated with the two or more communication modes, the configuration information indicating at least two sets of parameter values, wherein each set of parameter values is associated with a respective communication mode of the two or more communication modes; and
communicate with the UE based at least in part on the at least two sets of parameter values.

26. The apparatus of claim 25, wherein the two or more communication modes comprise at least one of:
a first mode in which the UE comprises an HD UE and the network node provides an HD cell, wherein, in the first mode, the UE communicates with the network node in association with one communication direction during a time period;
a second mode in which the UE comprises a first HD UE of a plurality of HD UEs and the network node provides an SBFD cell, wherein, in the second mode, the UE communicates with the network node in association with one communication direction during the time period;
a third mode in which the UE comprises an SBFD UE and the network node provides an SBFD cell, wherein, in the third mode, the UE communicates with the network node in association with two communication directions during the time period; or
a fourth mode in which the UE comprises an SBFD UE and the network node provides an HD cell or transmission reception point (TRP) of a plurality of HD cells, wherein, in the fourth mode, the UE communicates via the cell or the TRP in association with a first communication direction during the time period and via an additional cell or an additional TRP in association with a second communication direction during the time period.

27. An apparatus for wireless communication at a user equipment (UE), comprising:
one or more memories; and
one or more processors, the one or more processors, individually or collectively and based at least in part on information stored in the one or more memories, being configured to:
receive, from a network node, configuration information associated with two or more communication modes, of a plurality of communication modes, the two or more communication modes comprising at least one FD mode;
communicate with the network node, in association with a first communication mode of the two or more communication modes; and
communicate, associated with a mode transition condition, with the network node in association with a second communication mode of the two or more communication modes, wherein the mode transition condition is associated with a maximum number of transition points during a specified time period.

28. The apparatus of claim 27, wherein the one or more processors are further configured to receive, from the network node, a communication mode indication indicative of an operation mode of the two or more communication modes, wherein communicating with the network node comprises communicating in association with the operation mode.

29. An apparatus for wireless communication at a network node, comprising:
one or more memories; and
one or more processors, the one or more processors, individually or collectively and based at least in part on information stored in the one or more memories, being configured to:
transmit, to a user equipment (UE), configuration information associated with two or more communication modes, of a plurality of communication modes, the two or more communication modes comprising at least one FD mode;
communicate with the UE in association with a first communication mode of the two or more communication modes; and
communicate, associated with a mode transition condition, with the UE in association with a second communication mode of the two or more communication modes, wherein the mode transition condition is associated with a maximum number of transition points during a specified time period.

30. The apparatus of claim 29, wherein the one or more processors are further configured to transmit, to the UE, a communication mode indication indicative of an operation mode of the two or more communication modes, wherein communicating with the UE comprises communicating in association with the operation mode.
